(19) United States
(12) Patent Application Publication
(10) Pub. No.: US 2025/0080878 A1
(43) Pub. Date: Mar. 6, 2025

(54) PHOTOELECTRIC CONVERSION DEVICE AND METHOD OF DRIVING PHOTOELECTRIC CONVERSION DEVICE

(71) Applicant: CANON KABUSHIKI KAISHA, Tokyo (JP)

(72) Inventors: YU MAEHASHI, Hokkaido (JP); KAZUHIRO MORIMOTO, Kanagawa (JP)

(21) Appl. No.: 18/768,967

(22) Filed: Jul. 10, 2024

(30) Foreign Application Priority Data
Aug. 31, 2023 (JP) 2023-141408

(51) Int. Cl. H04N 25/773; H04N 25/705; H04N 25/76; H04N 25/767; H04N 25/768

(52) U.S. Cl. CPC H04N 25/773; H04N 25/705; H04N 25/767; H04N 25/768; H04N 25/7795

(57) ABSTRACT

A photoelectric conversion device includes an APD, a signal processing circuit including a first input node connected to one node of the APD and a second input node to which a periodic first control signal is input, and a recharge circuit connected to the one node of the APD and controlling a recharge operation of the APD in accordance with a periodic second control signal. The signal processing circuit switches, in accordance with the first control signal, between a first mode in which an output value is changed in accordance with a signal to the first input node and a second mode in which a fixed value is output regardless of a signal input to the first input node, and outputs once a first value in the first mode when avalanche multiplication occurs in the APD two or more times during one cycle of the second control signal.

### BACKGROUND

### Technical Field

The present invention relates to a photoelectric conversion device and a method of driving a photoelectric conversion device.

### Description of the Related Art

As a photoelectric conversion element, an APD (Avalanche Photo Diode) and SPAD (Single Photon Avalanche Diode), which multiply charge generated by incidence of photon by avalanche breakdown, are known. These photoelectric conversion elements are used in, e.g., photoelectric conversion devices having a function of counting the number of photons detected. Japanese Patent Application Laid-Open No. 2020-123847 describes a photoelectric conversion device that alternately controls an APD between a standby state in which avalanche multiplication is possible and a recharge state in which the APD is returned to a state in which avalanche multiplication is possible again, and counts the number of periods in which avalanche multiplication occurs among a plurality of periods controlled to the standby state.

However, in the technique described in Japanese Patent Application Laid-Open No. 2020-123847, the number of periods in which avalanche multiplication occurs among a plurality of periods in which the APD is controlled to the standby state cannot be accurately counted in some cases.

### SUMMARY

An object of the present invention is to provide a photoelectric conversion device and a method of driving the same capable of accurately counting the number of periods in which avalanche multiplication occurs among a plurality of periods in which an APD is controlled to a standby state.

According to one disclosure of the present specification, there is provided a photoelectric conversion device including an avalanche photodiode, a first signal processing circuit including a first input node connected to one node of the avalanche photodiode and a second input node to which a periodic first control signal is input, and a recharge circuit connected to the one node of the avalanche photodiode and configured to control a recharge operation of the avalanche photodiode in accordance with a periodic second control signal, wherein the first signal processing circuit is configured to switch, in accordance with the first control signal, between a first mode in which an output value is changed in accordance with a signal to the first input node and a second mode in which a fixed value is output regardless of a signal input to the first input node, and wherein the first signal processing circuit is configured to output once a first value in the first mode when avalanche multiplication occurs in the avalanche photodiode two or more times during one cycle of the second control signal.

According to another disclosure of the present specification, there is provided a photoelectric conversion device including an avalanche photodiode, a first signal processing circuit including a first input node connected to one node of the avalanche photodiode and a second input node to which a periodic first control signal is input, and a recharge circuit connected to the one node of the avalanche photodiode and controlled by a periodic second control signal, wherein the first signal processing circuit is configured to be controlled, in accordance with the first control signal, to a first mode in which an output value is changed in accordance with a signal to the first input node and a second mode in which a fixed value is output regardless of a signal to the first input node, wherein the recharge circuit is configured to be controlled, in accordance with the second control signal, to a recharge operation mode in which a recharge operation in the avalanche photodiode is permitted and a quench operation mode in which a quench operation in the avalanche photodiode is permitted, and wherein a period in which the recharge circuit is controlled to the recharge operation mode overlaps a period in which the first signal processing circuit is controlled to the second mode and does not overlap a period in which the first signal processing circuit is controlled to the first mode.

According to yet another disclosure of the present specification, there is provided a photoelectric conversion device including an avalanche photodiode, a first signal processing circuit including a first input node connected to one node of the avalanche photodiode and a second input node to which a periodic first control signal is input, and a recharge circuit connected to the one node of the avalanche photodiode and controlled by a periodic second control signal, wherein the recharge circuit is configured to be controlled, in accordance with the second control signal, to a recharge operation mode in which a recharge operation in the avalanche photodiode is permitted and a quench operation mode in which a quench operation in the avalanche photodiode is permitted, and wherein the first signal processing circuit is configured to output a second value when the first control signal is at a first level, output a first value when the first control signal is at a second level different from the first level and the avalanche photodiode is in a discharge state in which avalanche multiplication does not occur, and hold an output value when the first control signal is at the second level and the avalanche photodiode is in a standby state in which avalanche multiplication is possible.

According to still another disclosure of the present specification, there is provided a method of driving a photoelectric conversion device including an avalanche photodiode, a first signal processing circuit including a first input node connected to one node of the avalanche photodiode and a second input node to which a periodic first control signal is input, and a recharge circuit connected to the one node of the avalanche photodiode and controlled by a periodic second control signal, the method including controlling, in accordance with the first control signal, the first signal processing circuit to a first mode in which an output value changes in accordance with a signal to the first input node and a second mode in which a fixed value is output regardless of a signal to the first input node, and when the recharge circuit controls, in accordance with the second control signal, to a recharge operation mode in which a recharge operation in the avalanche photodiode is permitted and to a quench operation mode in which a quench operation in the avalanche photodiode is permitted, controlling so that a period in which the recharge circuit is controlled to the recharge operation mode overlaps a period in which the first signal processing circuit is controlled to the second mode and does not overlap a period in which the first signal processing circuit is controlled to the first mode.

Further features of the present invention will become apparent from the following description of exemplary embodiments with reference to the attached drawings.

### BRIEF DESCRIPTION OF THE DRAWINGS

FIG. 1 and FIG. 2 are block diagrams illustrating a schematic configuration of a photoelectric conversion device according to a first embodiment of the present invention.

FIG. 3 is a block diagram illustrating a configuration example of a pixel of the photoelectric conversion device according to the first embodiment of the present invention.

FIG. 4 is a perspective view illustrating a configuration example of the photoelectric conversion device according to the first embodiment of the present invention.

FIG. 5A, FIG. 5B, and FIG. 5C are diagrams illustrating the basic operation of a photoelectric conversion unit in the photoelectric conversion device according to the first embodiment of the present invention.

FIG. 6 is a circuit diagram illustrating a configuration example of the pixel in the photoelectric conversion device according to the first embodiment of the present invention.

FIG. 7, FIG. 8, and FIG. 11 are timing charts illustrating a general operation of the pixel circuit illustrated in FIG. 6.

FIG. 9 is a timing chart illustrating a method of driving the photoelectric conversion device according to the first embodiment of the present invention.

FIG. 10 is a circuit diagram illustrating a configuration example of a pixel in a photoelectric conversion device according to a second embodiment of the present invention.

FIG. 12 is a timing chart illustrating a method of driving the photoelectric conversion device according to the second embodiment of the present invention.

FIG. 13 is a circuit diagram illustrating a configuration example of a pixel in a photoelectric conversion device according to a third embodiment of the present invention.

FIG. 14, FIG. 15, and FIG. 16 are timing charts illustrating a method of driving the photoelectric conversion device according to the third embodiment of the present invention.

FIG. 17 is a block diagram illustrating a schematic configuration of a photodetection system according to a fourth embodiment of the present invention.

FIG. 18 is a block diagram illustrating a schematic configuration of a range image sensor according to a fifth embodiment of the present invention.

FIG. 19 is a schematic diagram illustrating a configuration example of an endoscopic surgical system according to a sixth embodiment of the present invention.

FIG. 20A, FIG. 20B and FIG. 20C are schematic diagrams illustrating an example of the configuration of a movable object according to a seventh embodiment of the present invention.

FIG. 21 is a block diagram illustrating a schematic configuration of a photodetection system according to the seventh embodiment of the present invention.

FIG. 22 is a flowchart illustrating the operation of the photodetection system according to the seventh embodiment of the present invention.

FIG. 23A and FIG. 23B are schematic diagrams illustrating a schematic configuration of a photodetection system according to an eighth embodiment of the present invention.

FIG. 24 is a block diagram illustrating a schematic configuration of equipment according to a ninth embodiment of the present invention.

### DESCRIPTION OF THE EMBODIMENTS

The following embodiments are intended to embody the technical idea of the present invention, and do not limit the present invention. The sizes and positional relationships of members illustrated in the drawings may be exaggerated for clarity of description. In the following description, the same components are denoted by the same reference numerals, and the description thereof may be omitted.

### First Embodiment

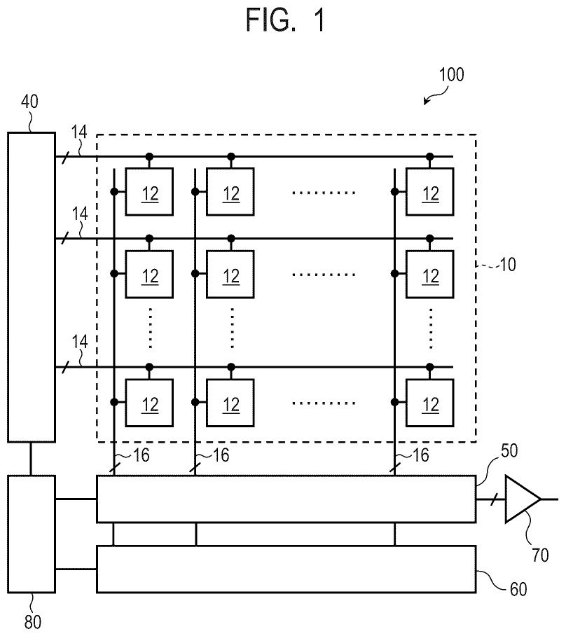

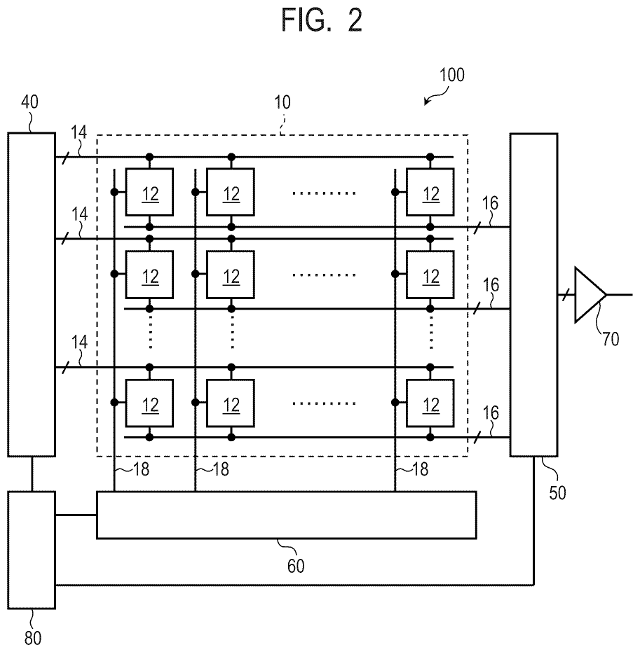

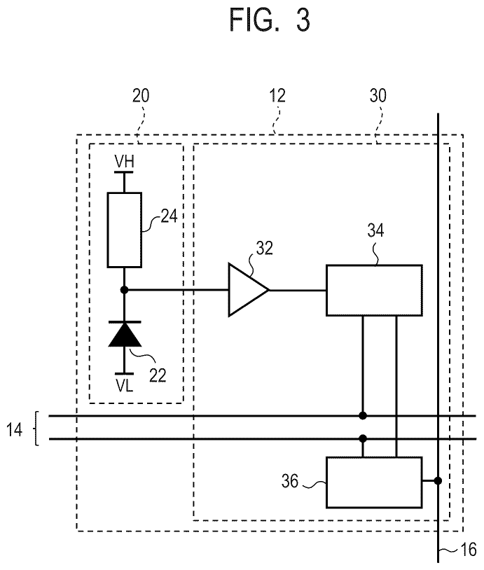

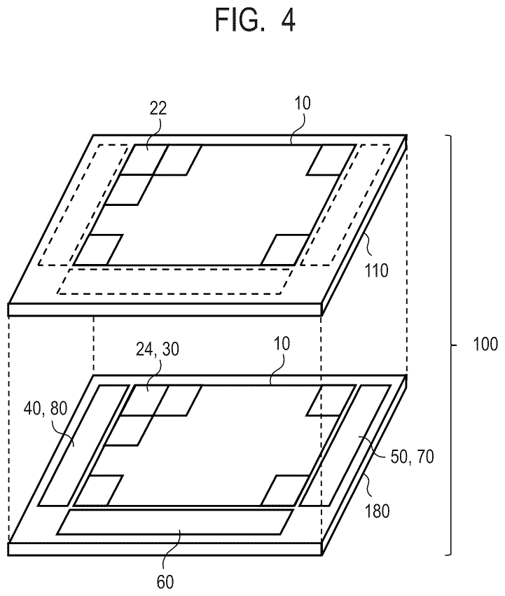

A schematic configuration of a photoelectric conversion device according to a first embodiment of the present invention will be described with reference to FIG. 1 to FIG. 4. FIG. 1 and FIG. 2 are block diagrams illustrating a schematic configuration of the photoelectric conversion device according to the present embodiment. FIG. 3 is a block diagram illustrating a configuration example of a pixel of the photoelectric conversion device according to the present embodiment. FIG. 4 is a perspective view illustrating a configuration example of the photoelectric conversion device according to the present embodiment.

As illustrated in FIG. 1, a photoelectric conversion device 100 according to the present embodiment includes a pixel unit 10, a vertical scanning circuit unit 40, a readout circuit unit 50, a horizontal scanning circuit unit 60, an output circuit unit 70, and a control pulse generation unit 80.

The pixel unit 10 is provided with a plurality of pixels 12 arranged in an array so as to form a plurality of rows and a plurality of columns. As described later, each pixel 12 may include a photoelectric conversion unit including a photoelectric conversion element and a pixel signal processing unit that processes a signal output from the photoelectric conversion unit. The number of pixels 12 included in the pixel unit 10 is not particularly limited. For example, like a general digital camera, the pixel unit 10 may be constituted by a plurality of pixels 12 arranged in an array of several thousand rows x several thousand columns. Alternatively, the pixel unit 10 may include a plurality of pixels 12 arranged in one row or one column. Alternatively, the pixel unit 10 may include one pixel 12.

In each row of the pixel array of the pixel unit 10, a control line 14 is arranged so as to extend in a first direction (lateral direction in FIG. 1). Each of the control lines 14 is connected to the pixels 12 arranged in the first direction on the corresponding row, respectively, and forms a signal line common to these pixels 12. The first direction in which the control lines 14 extend may be referred to as a row direction or a horizontal direction. Each of the control lines 14 may include a plurality of signal lines for supplying a plurality of types of control signals to the pixels 12. The control line 14 of each row is connected to the vertical scanning circuit unit 40.

In addition, in each column of the pixel array of the pixel unit 10, a data line 16 is arranged so as to extend in a second direction (vertical direction in FIG. 1) intersecting the first direction. Each of the data lines 16 is connected to the pixels 12 arranged in the second direction on the corresponding column, respectively, and forms a signal line common to these pixels 12. The second direction in which the data lines 16 extend may be referred to as a column direction or a vertical direction. Each of the data lines 16 may include a plurality of signal lines for transferring a digital signal of a plurality of bits output from the pixel 12 on a bit-by-bit basis.

The control line 14 of each row is connected to the vertical scanning circuit unit 40. The vertical scanning circuit unit 40 is a control unit having a function of receiving a control signal output from the control pulse generation unit 80, generating a control signal for driving the pixels 12, and supplying the generated control signal to the pixels 12 via the control lines 14. A logic circuit such as a shift register or an address decoder may be used as the vertical scanning circuit unit 40. The vertical scanning circuit unit 40 sequentially scans the pixels 12 in the pixel unit 10 in units of rows, and makes the pixels 12 output pixel signals to the readout circuit unit 50 via the data lines 16.

The data line 16 of each column is connected to the readout circuit unit 50. The readout circuit unit 50 includes a plurality of holding units (not illustrated) provided corresponding to each column of the pixel array of the pixel unit 10, and has a function of holding the pixel signals of the pixels 12 of the respective columns output from the pixel unit 10 in units of rows via the data lines 16 in the holding units of the corresponding columns.

The horizontal scanning circuit unit 60 is a control unit that receives a control signal output from the control pulse generation unit 80, generates a control signal for reading out a pixel signal from the holding unit of each column of the readout circuit unit 50, and supplies the generated control signal to the readout circuit unit 50. A logic circuit such as a shift register or an address decoder may be used as the horizontal scanning circuit unit 60. The horizontal scanning circuit unit 60 sequentially scans the holding units of the respective columns of the readout circuit unit 50, and makes the readout circuit unit 50 sequentially output the pixel signals held in the holding units to the output circuit unit 70.

The output circuit unit 70 includes an external interface circuit, and is a circuit unit for outputting the pixel signals output from the readout circuit unit 50 to the outside of the photoelectric conversion device 100. The external interface circuit included in the output circuit unit 70 is not particularly limited. As the external interface circuit, for example, a SerDes (SERializer/DESerializer) transmission circuit such as a LVDS (Low Voltage Differential Signaling) circuit or a SLVS (Scalable Low Voltage Signaling) circuit may be applied.

The control pulse generation unit 80 is a control circuit for generating a control signal for controlling the operations and timings of the vertical scanning circuit unit 40, the readout circuit unit 50, and the horizontal scanning circuit unit 60, and supplying the generated control signals to each functional block. At least a part of the control signals for controlling the operations and timings of the vertical scanning circuit unit 40, the readout circuit unit 50, and the horizontal scanning circuit unit 60 may be supplied from the outside of the photoelectric conversion device 100.

The connection mode of each functional block of the photoelectric conversion device 100 is not limited to the configuration example of FIG. 1, and may be configured as illustrated in FIG. 2, for example.

In the configuration example of FIG. 2, the data line 16 extending in the first direction is arranged in each row of the pixel array of the pixel unit 10. Each of the data lines 16 is connected to the pixels 12 arranged in the first direction on the corresponding row, respectively, and forms a signal line common to these pixels 12. A control line 18 extending in the second direction is arranged in each column of the pixel array of the pixel unit 10. Each of the control lines 18 is connected to the pixels 12 arranged in the second direction on the corresponding column, respectively, and forms a signal line common to these pixels 12.

The control line 18 of each column is connected to the horizontal scanning circuit unit 60. The horizontal scanning circuit unit 60 receives a control signal output from the control pulse generation unit 80, generates a control signal for reading out the pixel signals from the pixels 12, and supplies the generated control signal to the pixels 12 via the control lines 18. Specifically, the horizontal scanning circuit unit 60 sequentially scans the plurality of pixels 12 of the pixel unit 10 in units of columns, and makes the pixels 12 of each row belonging to the selected column output the pixel signals to the data lines 16.

The data line 16 of each row is connected to the readout circuit unit 50. The readout circuit unit 50 includes a plurality of holding units (not illustrated) provided corresponding to each row of the pixel array of the pixel unit 10, and has a function of holding the pixel signals of the pixels 12 of the respective rows output from the pixel unit 10 in units of columns via the data lines 16 in the holding units of the corresponding rows.

The readout circuit unit 50 receives the control signal output from the control pulse generation unit 80, and sequentially outputs the pixel signals held in the holding units of the respective rows to the output circuit unit 70.

Other configurations in the configuration example of FIG. 2 may be the same as those in the configuration example of FIG. 1.

As illustrated in FIG. 3, each pixel 12 includes a photoelectric conversion unit 20 and a pixel signal processing unit 30. The photoelectric conversion unit 20 includes a photoelectric conversion element 22 and a quenching element 24. The pixel signal processing unit 30 is a signal processing circuit that processes a signal output from the photoelectric conversion unit 20, and includes, for example, a waveform shaping circuit 32, a counter circuit 34, and a selection circuit 36. The pixel signal processing unit 30 may include at least the waveform shaping circuit 32. The pixel signal processing unit 30 may further include a counter saturation detection circuit that detects saturation of the count value in the counter circuit 34.

The photoelectric conversion element 22 may be an avalanche photodiode (hereinafter referred to as “APD”). An anode of the APD constituting the photoelectric conversion element 22 is connected to a node to which a voltage VL is supplied. A cathode of the APD constituting the photoelectric conversion element 22 is connected to one terminal of the quenching element 24. A connection node between the photoelectric conversion element 22 and the quenching element 24 is an output node of the photoelectric conversion unit 20. The other terminal of the quenching element 24 is connected to a node to which a voltage VH higher than the voltage VL is supplied. The voltage VL and the voltage VH are set so that a reverse bias voltage sufficient for the APD to perform the avalanche multiplication operation is applied. In one example, a negative high voltage is applied as the voltage VL, and a positive voltage comparable to the power supply voltage is applied as the voltage VH. For example, the voltage VL is −30 V, and the voltage VH is 1 V.

The photoelectric conversion element 22 may be configured by an APD as described above. When a reverse bias voltage sufficient to perform the avalanche multiplication operation is supplied to the APD, charge generated by light incident on the APD cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than a breakdown voltage of the APD. The linear mode is an operation mode in which a voltage applied between the anode and the cathode is set to a reverse bias voltage close to or lower than the breakdown voltage of the APD. An APD that operates in Geiger mode is referred to as SPAD (Single Photon Avalanche Diode). The APD constituting the photoelectric conversion element 22 may operate in a linear mode or a Geiger mode.

In the present embodiment, the anode of the APD is set to a fixed potential, and a signal is extracted from the cathode side. Therefore, a semiconductor region of a first conductivity type having charge of the same polarity as the signal charge as a majority carrier is n-type semiconductor region, and a semiconductor region of a second conductivity type having charge of the polarity different from the signal charge as a majority carrier is p-type semiconductor region. The carriers of the first conductivity type are electrons, and the carriers of the second conductivity type are holes. The present invention is also applicable to a case where the cathode of the APD is set to a fixed potential and a signal is taken out from the anode side. In this case, the semiconductor region of the first conductivity type having charge of the same polarity as the signal charge as a majority carriers is p-type semiconductor region, and the semiconductor region of the second conductivity type having charge of a polarity different from the signal charge as a majority carriers is n-type semiconductor region. Although a case where one node of the APD is set to a fixed potential will be described below, the potentials of both nodes may vary.

The quenching element 24 has a function of converting a change in the avalanche current generated in the photoelectric conversion element 22 into a voltage signal. In addition, the quenching element 24 functions as a load circuit (quenching circuit) at the time of signal multiplication by avalanche multiplication, and has a function of suppressing avalanche multiplication by reducing a voltage applied to the photoelectric conversion element 22. The operation in which the quenching element 24 suppresses avalanche multiplication is called a quench operation. The quenching element 24 has a function of returning the voltage supplied to the photoelectric conversion element 22 to the voltage VH by flowing a current corresponding to the voltage drop due to the quench operation. The operation of returning the voltage supplied from the quenching element 24 to the photoelectric conversion element 22 to the voltage VH is called a recharge operation. The quenching element 24 may be configured by a resistor element, a MOS transistor, or the like. In this specification, the quenching element 24 may be referred to as a recharge circuit.

The waveform shaping circuit 32 includes an input node to which the output signal of the photoelectric conversion unit 20 is supplied and an output node. The waveform shaping circuit 32 has a function of converting an analog signal supplied from the photoelectric conversion unit 20 into a pulse signal. The waveform shaping circuit 32 may be configured by a logic circuit including a NOT circuit (inverter circuit), a NOR circuit, a NAND circuit, and the like. The output node of the waveform shaping circuit 32 is connected to the counter circuit 34.

The counter circuit 34 has an input node to which the output signal of the waveform shaping circuit 32 is supplied, an input node connected to the control line 14, and an output node. The counter circuit 34 has a function of counting pulses superimposed on a signal output from the waveform shaping circuit 32 and holding a count value which is a count result. The signal supplied from the vertical scanning circuit unit 40 to the counter circuit 34 via the control line 14 may include an enable signal for controlling a pulse counting period (exposure period), a reset signal for resetting a count value held by the counter circuit 34, and the like. The output node of the counter circuit 34 is connected to the data line 16 via the selection circuit 36.

The selection circuit 36 has a function of switching an electrical connection state (connection or non-connection) between the counter circuit 34 and the data line 16. The selection circuit 36 switches the connection state between the counter circuit 34 and the data line 16 in accordance with a control signal supplied from the vertical scanning circuit unit 40 via the control line 14 (in the configuration example of FIG. 2, a control signal supplied from the horizontal scanning circuit unit 60 via the control line 18). The selection circuit 36 may include a buffer circuit for outputting a signal.

The pixel 12 is typically a unit structure that outputs a pixel signal for forming an image. However, in the case of aiming at distance measurement using a TOF (Time of Flight) method, the pixel 12 does not necessarily need to be a unit structure that outputs a pixel signal for forming an image. That is, the pixel 12 may be a unit structure that outputs a signal for measuring the time at which light arrives and the amount of light.

One pixel signal processing unit 30 is not necessarily provided for each pixel 12, and one pixel signal processing unit 30 may be provided for a plurality of pixels 12.

In this case, the signal processing of the plurality of pixels 12 may be sequentially performed using one pixel signal processing unit 30.

The photoelectric conversion device 100 according to the present embodiment may be formed on one substrate, or may be configured as a stacked-type photoelectric conversion device in which a plurality of substrates are stacked. In the latter case, for example, as illustrated in FIG. 4, the photoelectric conversion device may be configured as a stacked-type photoelectric conversion device in which a sensor substrate 110 and a circuit substrate 180 are stacked and electrically connected to each other. At least the photoelectric conversion element 22 among the constituent elements of the pixel 12 may be disposed on the sensor substrate 110. In addition, among the constituent elements of the pixels 12, the quenching element 24 and the pixel signal processing unit 30 may be disposed on the circuit substrate 180.

The photoelectric conversion element 22, and the quenching element 24 and the pixel signal processing unit 30 are electrically connected to each other via an interconnection provided for each pixel 12. The circuit substrate 180 may be further provided with the vertical scanning circuit unit 40, the readout circuit unit 50, the horizontal scanning circuit unit 60, the output circuit unit 70, and the control pulse generation unit 80.

The photoelectric conversion element 22, and the quenching element 24 and the pixel signal processing unit 30 of each pixel 12 may be provided on the sensor substrate 110 and the circuit substrate 180 so as to overlap each other in a plan view. The vertical scanning circuit unit 40, the readout circuit unit 50, the horizontal scanning circuit unit 60, the output circuit unit 70, and the control pulse generation unit 80 may be disposed around the pixel unit 10 including the plurality of pixels 12. Here, the term “plan view” refers to a view from a direction perpendicular to the surface of the sensor substrate 110.

By configuring the stacked-type photoelectric conversion device 100, it is possible to increase the degree of integration of elements and achieve higher functionality. In particular, by arranging the photoelectric conversion element 22, and the quenching element 24 and the pixel signal processing unit 30 on different substrates, the photoelectric conversion element 22 may be arranged at high density without sacrificing the light receiving area of the photoelectric conversion element 22, and the photon detection efficiency may be improved.

The number of substrates constituting the photoelectric conversion device 100 is not limited to two, and three or more substrates may be stacked to constitute the photoelectric conversion device 100.

In FIG. 4, a diced chip is assumed as the sensor substrate 110 and the circuit substrate 180, but the sensor substrate 110 and the circuit substrate 180 are not limited to chips. For example, each of the sensor substrate 110 and the circuit substrate 180 may be a wafer. In addition, the sensor substrate 110 and the circuit substrate 180 may be stacked in a wafer state and then diced, or may be stacked and bonded after being formed into chips.

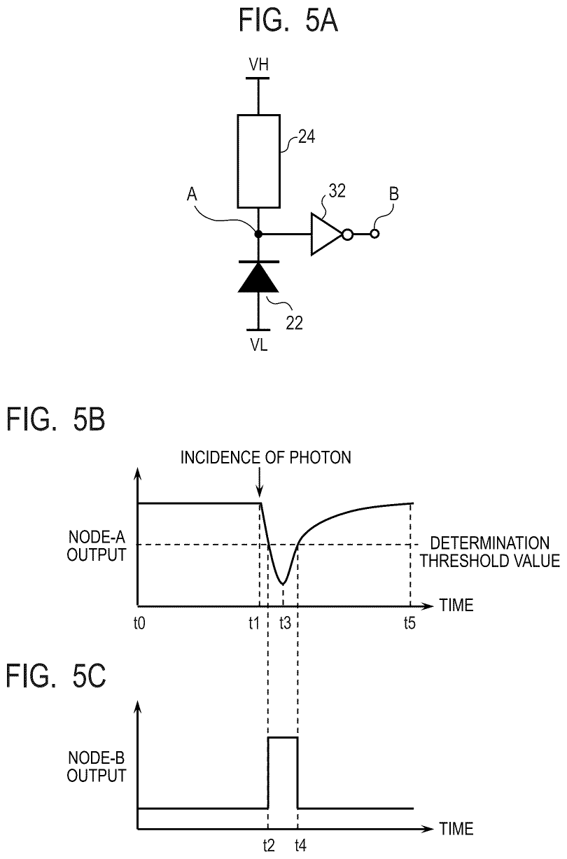

Next, a basic operation of the photoelectric conversion unit 20 in the photoelectric conversion device according to the present embodiment will be described with reference to FIG. 5A to FIG. 5C. FIG. 5A to FIG. 5C are diagrams illustrating the basic operation of the photoelectric conversion unit in the photoelectric conversion device according to the present embodiment. FIG. 5A is a circuit diagram of the photoelectric conversion unit 20 and the waveform shaping circuit 32, FIG. 5B illustrates a waveform of a signal at an input node (node-A) of the waveform shaping circuit 32, and FIG. 5C illustrates a waveform of a signal at an output node (node-B) of the waveform shaping circuit 32. Here, in order to simplify the description, it is assumed that the waveform shaping circuit 32 is configured by an inverter circuit.

At time t0, a reverse bias voltage having a potential difference corresponding to (VH-VL) is applied to the photoelectric conversion element 22. Although the reverse bias voltage sufficient to cause avalanche multiplication is applied between the anode and the cathode of the APD constituting the photoelectric conversion element 22, no carriers serving as seeds of avalanche multiplication exist in a state where photons are not incident on the photoelectric conversion element 22. Therefore, avalanche multiplication does not occur in the photoelectric conversion element 22, and no current flows through the photoelectric conversion element 22.

At the subsequent time t1, it is assumed that a photon is incident on the photoelectric conversion element 22.

When a photon enters the photoelectric conversion element 22, an electron-hole pair is generated by photoelectric conversion, avalanche multiplication occurs using these carriers as seeds, and an avalanche multiplication current flows through the photoelectric conversion element 22. When the avalanche multiplication current flows through the quenching element 24, a voltage drop occurs due to the quenching element 24, and the voltage of the node-A starts to drop. When the voltage drop amount of the node-A becomes large and the avalanche multiplication is stopped at time t3, the voltage level of the node-A no longer drops.

When the avalanche multiplication in the photoelectric conversion element 22 is stopped, a current that compensates for the voltage drop flows from the node to which the voltage VL is supplied to the node-A through the photoelectric conversion element 22, and the voltage of the node-A gradually increases. Thereafter, at time t5, the node-A is settled to the original voltage level.

The waveform shaping circuit 32 binarizes the signal input from the node-A according to a predetermined determination threshold value, and outputs the signal from the node-B. Specifically, the waveform shaping circuit 32 outputs a low-level signal from the node-B when the voltage level of the node-A exceeds the determination threshold value, and outputs a high-level signal from the node-B when the voltage level of the node-A is equal to or less than the determination threshold value. For example, as illustrated in FIG. 5B, it is assumed that the voltage of the node-A is equal to or lower than the determination threshold value in the period from the time t2 to the time t4. In this case, as illustrated in FIG. 5C, the signal level at the node-B becomes low-level in the period from the time to t0 the time t2 and the period from the time t4 to the time t5, and becomes high-level in the period from the time t2 to the time t4.

Thus, the analog signal input from the node-A is waveform-shaped into a digital signal by the waveform shaping circuit 32. A pulse signal output from the waveform shaping circuit 32 in response to incidence of a photon on the photoelectric conversion element 22 is a photon detection pulse signal.

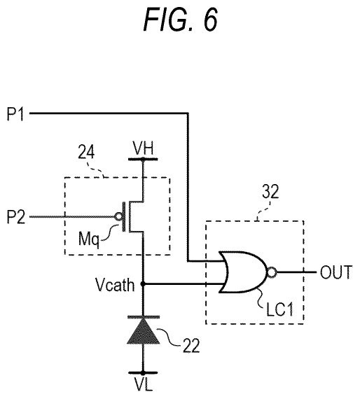

Next, a circuit configuration of the pixel 12 in the photoelectric conversion device according to the present embodiment will be described with reference to FIG. 6. FIG. 6 is a circuit diagram illustrating a configuration example of the pixel in the photoelectric conversion device according to the present embodiment. FIG. 6 illustrates the photoelectric conversion element 22, the quenching element 24, and the waveform shaping circuit 32 among the constituent elements of the pixel 12. The other constituent elements of the pixel 12 are the same as those in FIG. 3.

In the pixel 12 of the photoelectric conversion device according to the present embodiment, as illustrated in FIG. 6, the quenching element 24 is formed of a p-channel MOS transistor Mq, and the waveform shaping circuit 32 is formed of a two-input NOR circuit LC1. A source of the p-channel MOS transistor Mq is connected to the node to which the voltage VH is supplied. A drain of the p-channel MOS transistor Mq is connected to the cathode of the APD constituting the photoelectric conversion element 22. A connection node between the photoelectric conversion element 22 and the p-channel MOS transistor Mq is the output node of the photoelectric conversion unit 20. The anode of the APD is connected to the node to which the voltage VL is supplied. The control signal P2 is supplied from the vertical scanning circuit unit 40 (or the horizontal scanning circuit unit 60) to a gate of the p-channel MOS transistor Mq. The output node of the photoelectric conversion unit 20 is connected to one input node of the NOR circuit LC1. A control signal P1 is supplied from the vertical scanning circuit unit 40 (or the horizontal scanning circuit unit 60) to the other input node of the NOR circuit LC1. An output node of the NOR circuit LC1 is connected to the input node of the counter circuit 34 (not illustrated in FIG. 6). The control signals P1 and P2 are periodic signals that repeat high-level and low-level at a constant cycle, and may be generated from, for example, a clock signal.

The p-channel MOS transistor Mq serves as a recharge circuit that controls the recharge operation of the APD in accordance with the periodic control signal P2. For example, the p-channel MOS transistor Mq may be controlled according to the control signal P2 to a recharge operation mode in which the recharge operation in the APD is permitted and a quench operation mode in which the quench operation in the APD is permitted. During the period in which the p-channel MOS transistor Mq operates in the recharge operation mode, the APD may be in the recharge state. In addition, during a period in which the p-channel MOS transistor Mq operates in the quench operation mode, the APD may be in a standby state. The waveform shaping circuit 32 is capable of switching between a first mode in which an output value changes in accordance with the cathode voltage Vcath of the APD and a second mode in which a fixed value is output regardless of the cathode voltage Vcath of the APD, in accordance with the control signal P1.

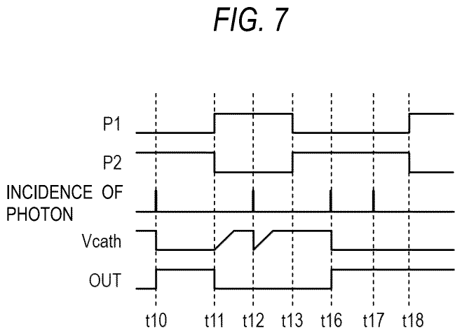

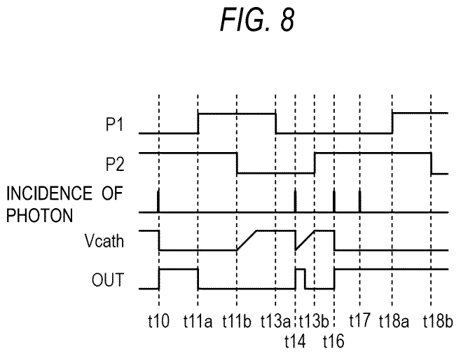

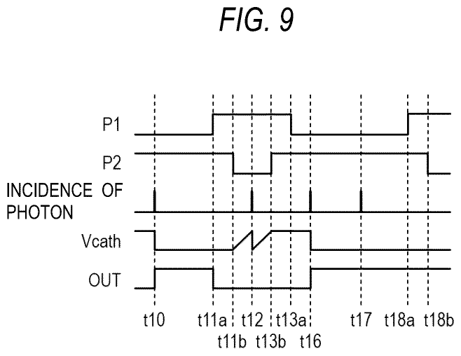

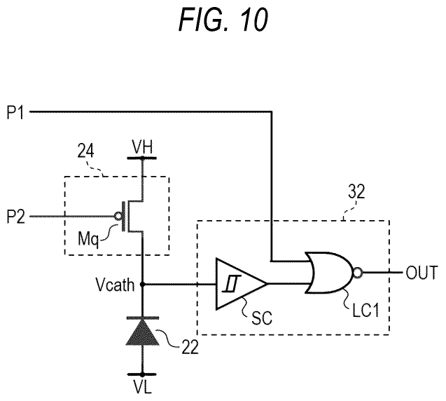

Next, an operation of the photoelectric conversion device according to the present embodiment will be described with reference to FIG. 7 to FIG. 9. FIG. 7 and FIG. 8 are timing charts illustrating a general operation of the pixel circuit illustrated in FIG. 6. FIG. 9 is a timing chart illustrating a method of driving the photoelectric conversion device according to the present embodiment.

First, a general operation of the pixel circuit illustrated in FIG. 6 will be described with reference to FIG. 7 and FIG. 8.

FIG. 7 is a timing chart of an ideal state in which no phase difference occurs between the control signal P1 and the control signal P2. FIG. 8 is a timing chart when a phase difference occurs between the control signal P1 and the control signal P2. In both cases, in the initial state before time t0, the control signal P1 is at low-level and the control signal P2 is at high-level. The p-channel MOS transistor Mq is turned off in response to the control signal P2 at high-level, and operates in the quench operation mode. Further, the waveform shaping circuit 32 receives the control signal P1 at low-level, and is a state in which the value of the output OUT changes in accordance with the cathode voltage Vcath of the APD.

First, an operation in an ideal state in which no phase difference occurs between the control signal P1 and the control signal P2 will be described with reference to FIG. 7.

At time t10, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t11, the control signal P1 transitions from low-level to high-level. As a result, the signal level of the output OUT of the waveform shaping circuit 32 transitions from high-level to low-level. Similarly, at time t11, the control signal P2 transitions from high-level to low-level. As a result, the p-channel MOS transistor Mq is turned on in response to the control signal P2 at low-level, and shifts to the recharge operation mode. As a result, the APD is brought into the recharge state, and the cathode voltage Vcath returns to the voltage VH. When the cathode voltage Vcath returns to the voltage VH, the APD enters a standby state in which avalanche multiplication can be performed. In the recharge operation mode, the APD is always in a rechargeable state, and even if avalanche multiplication occurs in the APD and the cathode voltage Vcath decreases, when the avalanche multiplication stops, the cathode voltage Vcath returns to the voltage VH.

In the period in which the control signal P1 is at high-level and the control signal P2 is at low-level, the signal level of the output OUT of the waveform shaping circuit 32 is maintained at low-level even if a photon is incident. For example, when a photon is incident at time t12, the cathode voltage Vcath decreases due to avalanche multiplication by the incident photon, but is recharged and returns to the voltage VH as soon as the avalanche multiplication stops. The output OUT of the waveform shaping circuit 32 is maintained at low-level regardless of the change in the cathode voltage Vcath because the control signal P1 at high-level is input to the NOR circuit LC1. That is, the waveform shaping circuit 32 outputs a fixed value regardless of the cathode voltage Vcath.

At the subsequent time t13, the control signal P1 transitions from high-level to low-level, and the control signal P2 transitions from low-level to high-level. As a result, the p-channel MOS transistor Mq enters the quench operation mode again, and the waveform shaping circuit 32 returns to a state in which the output value changes in accordance with the cathode voltage Vcath again.

When a photon enters the photoelectric conversion element 22 at the subsequent time t16, the cathode voltage Vcath decreases due to avalanche multiplication in the APD, and the output OUT of the waveform shaping circuit 32 transitions from low-level to high-level. The counter circuit 34 in the subsequent stage counts the state transition of the output OUT from low-level to high-level, and increments the count value by one.

In a period in which the control signal P1 is at low-level and the control signal P2 is at high-level, that is, in the quench operation mode, even if the photon is incident again after the photon is detected once, the signal level of the output OUT of the waveform shaping circuit 32 is maintained at high-level.

For example, even if a photon is incident at time t17, avalanche multiplication does not occur because the APD is not recharged. Therefore, the output OUT of the waveform shaping circuit 32 is maintained at high-level. That is, it can be said that the period from the time t11 to the time t16 in this operation example is a period in which the APD is controlled to the standby state in which avalanche multiplication can be performed.

As described above, in the ideal state in which no phase difference occurs between the control signal P1 and the control signal P2, the avalanche multiplication generated during one cycle of the control signals P1 and P2 may be counted only once. In other words, when avalanche multiplication occurs in the APD two or more times during one cycle of the control signals P1 and P2, the pixel signal processing unit 30 outputs a first value only once in the first mode. Here, the first value is 1.

The start timing of one cycle of the control signals P1 and P2 may be arbitrarily determined. For example, the length of one cycle of the control signals P1 and P2 may be defined as the length of a period from the timing when the control signals P1 or P2 transitions from low-level to high-level to the timing when the control signals P1 or P2 next transitions from low-level to high-level. In the driving example of FIG. 7, for example, the length of the period from time t11 to time t18 corresponds to the length of one cycle of the control signals P1 and P2.

Next, an operation when a phase difference occurs between the control signal P1 and the control signal P2 will be described with reference to FIG. 8. Here, it is assumed that the control signal P2 is delayed with respect to the control signal P1.

At time t10, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t11a, the control signal P1 transitions from low-level to high-level, and the signal level of the output OUT of the waveform shaping circuit 32 transitions from high-level to low-level.

At the subsequent time t11b, it is assumed that the control signal P2 transitions from high-level to low-level later than the transition of the control signal P1. As a result, the p-channel MOS transistor Mq is turned on in response to the control signal P2 at low-level, and shifts to the recharge operation mode. As a result, the APD is recharged, and the cathode voltage Vcath returns to the voltage VH.

At the subsequent time t13a, the control signal P1 transitions from high-level to low-level. This allows the waveform shaping circuit 32 to change the value of the output OUT in accordance with the cathode voltage Vcath despite the fact that it is in the recharge period in which the control signal P2 is low-level. As a result, for example, when a photon enters the pixel 12 at the subsequent time t14, the cathode voltage Vcath decreases due to avalanche multiplication in the APD, but is recharged as soon as avalanche multiplication stops. The output OUT of the waveform shaping circuit 32 transitions to high-level in accordance with the decrease in the cathode voltage Vcath, and immediately transitions to low-level in accordance with the completion of the recharging. The counter circuit 34 in the subsequent stage counts the state transition of the output OUT from low-level to high-level, and increments the count value by one.

At the subsequent time t13b, when the control signal P2 transitions from low-level to high-level, the p-channel MOS transistor Mq is turned off in response to the control signal P2 at high-level, and returns to the quench operation mode.

When a photon enters the photoelectric conversion element 22 at the subsequent time t16, the cathode voltage Vcath decreases due to avalanche multiplication in the APD, and the output OUT of the waveform shaping circuit 32 transitions from low-level to high-level. The counter circuit 34 in the subsequent stage counts the state transition of the output OUT from low-level to high-level, and increments the count value by one.

As described above, in a case where the length of the period in which the control signal P1 is at high-level and the length of the period in which the control signal P2 is at low-level are the same, if a phase shift occurs in these periods, photons may be detected twice or more during one cycle of the control signals P1 and P2. In the driving example of FIG. 8, the length of one cycle of the control signal P1 corresponds to, for example, the length of a period from time t11a to time t18a. The length of one cycle of the control signal P2 corresponds to, for example, the length of a period from time t11b to time t18b.

If photons are detected two or more times during one cycle of the control signals P1 and P2, an accurate count value cannot be obtained in the counter circuit 34 in the subsequent stage. In addition, in a case where the pixel signal processing unit 30 includes a counter saturation detection circuit (not illustrated), there is a possibility that saturation detection of the count value cannot be performed at an accurate timing and the count value may return to the initial value.

Next, a method of driving the photoelectric conversion device according to the present embodiment will be described with reference to FIG. 9. In the driving method of the present embodiment, the control signals P1 and P2 are set so that a low-level period of the control signal P2 is in a high-level period of the control signal P1 so that photons can be detected only once during one cycle of the control signals P1 and P2. In other words, the period in which the p-channel MOS transistor Mq is controlled to the recharge operation mode overlaps the period in which the waveform shaping circuit 32 is controlled to the second mode and does not overlap the period in which the waveform shaping circuit 32 is controlled to the first mode.

At time t10, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t11a, the control signal P1 transitions from low-level to high-level, and the signal level of the output OUT of the waveform shaping circuit 32 transitions from high-level to low-level.

At the subsequent time t11b, the control signal P2 transitions from high-level to low-level later than the transition of the control signal P1. As a result, the p-channel MOS transistor Mq is turned on in response to the control signal P2 at low-level, and shifts to the recharge operation mode. As a result, the APD is recharged, and the cathode voltage Vcath returns to the voltage VH.

In this driving example, even if a photon is incident in this state, the signal level of the output OUT of the waveform shaping circuit 32 is maintained at low-level. For example, when a photon is incident at time t12, the cathode voltage Vcath decreases due to avalanche multiplication by the incident photon, but is recharged and returns to the voltage VH as soon as the avalanche multiplication stops. The output OUT of the waveform shaping circuit 32 receives the control signal P1 at high-level, and is maintained at low-level regardless of the change in the cathode voltage Vcath.

At the subsequent time t13b, when the control signal P2 transitions from low-level to high-level, the p-channel MOS transistor Mq is turned off in response to the control signal P2 at high-level, and returns to the quench operation mode.

At the subsequent time t13a, the control signal P1 transitions from high-level to low-level, and the waveform shaping circuit 32 again returns to a state in which the value of the output OUT changes according to the cathode voltage Vcath.

When a photon enters the photoelectric conversion element 22 at the subsequent time t16, the cathode voltage Vcath decreases due to avalanche multiplication in the APD, and the output OUT of the waveform shaping circuit 32 transitions from low- level to high-level. The counter circuit 34 in the subsequent stage counts the state transition of the output OUT from low-level to high-level, and increments the count value by one.

In a period in which the control signal P1 is at low-level and the control signal P2 is at high-level, even if the photon is incident again after the photon is detected once, the signal level of the output OUT of the waveform shaping circuit 32 is maintained at high-level. For example, even if a photon is incident at time t17, avalanche multiplication does not occur because the APD is not recharged. Therefore, the output OUT of the waveform shaping circuit 32 is maintained at high-level.

As described above, by setting the low-level period of the control signal P2 to be included in the high-level period of the control signal P1, the degree of difficulty of the phase management of the control signals P1 and P2 may be relaxed, and the avalanche multiplication may be detected only once during one cycle of the control signals P1 and P2.

In the driving example of FIG. 9, the length of one cycle of the control signal P1 corresponds to, for example, the length of a period from time t11a to time t18a. The length of one cycle of the control signal P2 corresponds to, for example, the length of a period from time t11b to time t18b.

As described above, according to the present embodiment, when the number of periods in which avalanche multiplication occurs is counted among a plurality of periods in which the APD is controlled to the standby state in which avalanche multiplication is possible, the number of periods in which avalanche multiplication occurs may be accurately counted.

### Second Embodiment

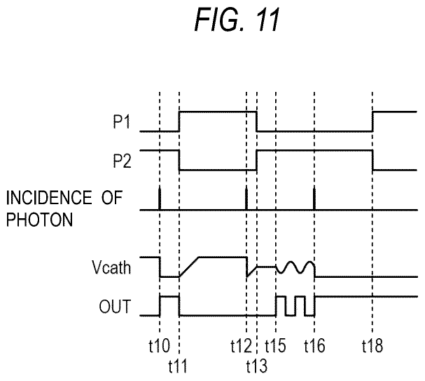

A photoelectric conversion device and a method of driving the same according to a second embodiment of the present invention will be described with reference to FIG. 10 to FIG. 12.

The photoelectric conversion device according to the present embodiment is basically the same as the photoelectric conversion device according to the first embodiment except that the configuration of the waveform shaping circuit 32 of the pixel 12 is different. In the present embodiment, differences between the waveform shaping circuit 32 of the present embodiment and the waveform shaping circuit 32 of the first embodiment will be mainly described, and description of portions common to the waveform shaping circuit 32 of the present embodiment and the waveform shaping circuit 32 of the first embodiment will be appropriately omitted.

First, a circuit configuration of the pixel 12 in the photoelectric conversion device according to the present embodiment will be described with reference to FIG. 10. FIG. 10 is a circuit diagram illustrating a configuration example of the pixel in the photoelectric conversion device according to the present embodiment. FIG. 10 illustrates the photoelectric conversion element 22, the quenching element 24, and the waveform shaping circuit 32 among the constituent elements of the pixel 12. The other constituent elements of the pixel 12 are the same as those in FIG. 3.

As illustrated in FIG. 10, the waveform shaping circuit 32 in the pixel 12 of the photoelectric conversion device according to the present embodiment further includes a Schmitt trigger circuit SC in addition to the NOR circuit LC1. An output node of the photoelectric conversion unit 20 is connected to an input node of the Schmitt trigger circuit SC. An output node of the Schmitt trigger circuit SC is connected to one input node of the NOR circuit LC1. The control signal P1 is supplied from the vertical scanning circuit unit 40 (or the horizontal scanning circuit unit 60) to the other input node of the NOR circuit LC1. An output node of the NOR circuit LC1 is connected to the input node of the counter circuit 34 (not illustrated in FIG. 10).

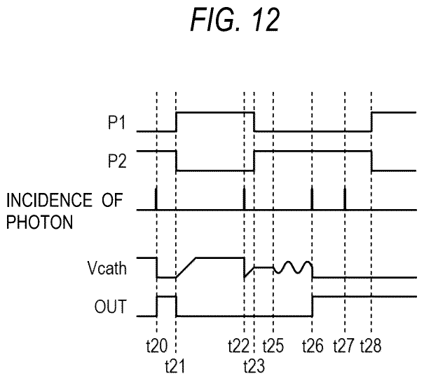

Next, an operation of the photoelectric conversion device according to the present embodiment will be described with reference to FIG. 11 and FIG. 12. FIG. 11 is a timing chart illustrating a general operation of the pixel circuit illustrated in FIG. 6. FIG. 12 is a timing chart illustrating a method of driving the photoelectric conversion device according to the present embodiment.

First, another problem that may occur in the pixel circuit illustrated in FIG. 6 will be described with reference to FIG. 11.

In the initial state before time t10, the p-channel MOS transistor Mq is turned off by receiving the control signal P2 at high-level, and operates in the quench operation mode. Further, the waveform shaping circuit 32 receives the control signal P1 at low-level, and changes the value of the output OUT in accordance with the cathode voltage Vcath of the APD.

At time t10, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t11, the control signal P1 transitions from low-level to high-level, and the signal level of the output OUT of the waveform shaping circuit 32 transitions from high-level to low-level. Similarly, at time t11, the control signal P2 transitions from high-level to low-level. As a result, the p-channel MOS transistor Mq is turned on in response to the control signal P2 at low-level, and shifts to the recharge operation mode. As a result, the APD is recharged, and the cathode voltage Vcath returns to the voltage VH.

In the period in which the control signal P1 is at high-level and the control signal P2 is at low-level, the signal level of the output OUT of the waveform shaping circuit 32 is maintained at low-level even if a photon is incident. For example, when a photon is incident at time t12, the cathode voltage Vcath decreases due to avalanche multiplication by the incident photon, but when the avalanche multiplication stops, the APD starts to be recharged. The output OUT of the waveform shaping circuit 32 is maintained at low-level regardless of the change in the cathode voltage Vcath because the control signal P1 at high-level is input to the NOR circuit LC1.

At the subsequent time t13, the control signal P1 transitions from high-level to low-level, and the control signal P2 transitions from low-level to high-level. As a result, the p-channel MOS transistor Mq enters the quench operation mode again, and the waveform shaping circuit 32 returns again to the state in which the value of the output OUT changes in accordance with the cathode voltage Vcath.

However, when the photon incidence timing (time t12) is just before the end of the recharge period (period from time t11 to time t13), the recharge period of the APD cannot be sufficiently secured, and the cathode voltage Vcath may not return to the voltage VH. In this case, the operation of recharging the cathode voltage Vcath stops at an intermediate potential between the voltage VL and the voltage VH. If the increase of the cathode voltage Vcath stops near the logical threshold value of the waveform shaping circuit 32, the cathode voltage Vcath may change across the logical threshold value when the cathode voltage Vcath fluctuates due to a disturbance. For example, when a disturbance enters the cathode terminal of the APD at time t15 and a variation of the cathode voltage Vcath occurs, chattering according to the variation of the cathode voltage Vcath occurs in the output OUT of the waveform shaping circuit 32. As a result, the waveform shaping circuit 32 continues to output the false signal to the subsequent stage until the cathode voltage Vcath is settled to a voltage distant from the vicinity of the logical threshold value. The counter circuit 34 at the subsequent stage increments the count value by one every time a false signal is received. Chattering appearing at the output OUT continues until photons are incident at time t16 and the cathode voltage Vcath is settled.

Next, a method of driving the photoelectric conversion device according to the present embodiment will be described with reference to FIG. 12.

The operation from time t20 to time t23 in the pixel 12 of the present embodiment is the same as the operation from time t10 to time t13 in FIG. 11. However, the waveform shaping circuit 32 of the present embodiment is configured by the Schmitt trigger circuit SC and the NOR circuit LC1, and chattering may be suppressed by an effect of hysteresis characteristics of the Schmitt trigger circuit SC.

For example, even if a disturbance enters the cathode terminal of the APD at time t25 and the cathode voltage Vcath varies, the output OUT of the waveform shaping circuit 32 does not transition according to the variation of the cathode voltage Vcath. Thereafter, at time t26, a photon is incident and the cathode voltage Vcath greatly transitions, so that the output OUT transitions from low-level to high-level. The counter circuit 34 in the subsequent stage counts the state transition of the output OUT from low-level to high-level, and increments the count value by one.

After the photon is detected once in the period in which the control signal P1 is at low-level and the control signal P2 is at high-level, even if the photon is incident again, the signal level of the output OUT of the waveform shaping circuit 32 is maintained at high-level. For example, even if a photon is incident at time t27, avalanche multiplication does not occur because the APD is not recharged. Therefore, the output OUT of the waveform shaping circuit 32 is maintained at high-level.

As described above, by connecting the Schmitt trigger circuit SC between the output node of the photoelectric conversion unit 20 and the input node of the NOR circuit LC1, chattering appearing in the output OUT may be suppressed. In addition, the pixel 12 of the present embodiment may be combined with the driving method of the first embodiment. That is, by setting the low-level period of the control signal P2 to be included in the high-level period of the control signal P1, avalanche multiplication may be detected only once during one cycle of the control signals P1 and P2. In the driving example of FIG. 12, the length of one cycle of the control signals P1 and P2 corresponds to, for example, the length of a period from time t21 to time t28.

As described above, according to the present embodiment, when the number of periods in which avalanche multiplication occurs is counted among a plurality of periods in which the APD is controlled to the standby state in which avalanche multiplication is possible, the number of periods in which avalanche multiplication occurs may be accurately counted.

### Third Embodiment

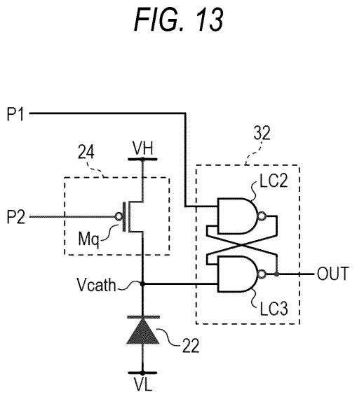

A photoelectric conversion device and a method of driving the same according to a third embodiment of the present invention will be described with reference to FIG. 13 to FIG. 16.

The photoelectric conversion device according to the present embodiment is basically the same as the photoelectric conversion device according to the first embodiment except that the configuration of the waveform shaping circuit 32 of the pixel 12 is different. In the present embodiment, differences between the waveform shaping circuit 32 of the present embodiment and the waveform shaping circuit 32 of the first embodiment will be mainly described, and description of portions common to the waveform shaping circuit 32 of the present embodiment and the waveform shaping circuit 32 of the first embodiment will be appropriately omitted.

First, a circuit configuration of the pixel 12 in the photoelectric conversion device according to the present embodiment will be described with reference to FIG. 13. FIG. 13 is a circuit diagram illustrating a configuration example of a pixel in the photoelectric conversion device according to the present embodiment. FIG. 13 illustrates the photoelectric conversion element 22, the quenching element 24, and the waveform shaping circuit 32 among the constituent elements of the pixel 12. The other constituent elements of the pixel 12 are the same as those in FIG. 3.

As illustrated in FIG. 13, the waveform shaping circuit 32 in the pixel 12 of the photoelectric conversion device according to the present embodiment includes two NAND circuits LC2 and LC3 forming a NAND SR latch. An output node of the photoelectric conversion unit 20 is connected to one input node of the NAND circuit LC3. An output node of the NAND circuit LC3 serving as an output node of the waveform shaping circuit 32 is connected to one input node of the NAND circuit LC2. An output node of the NAND circuit LC2 is connected to the other input node of the NAND circuit LC3. The control signal P1 is supplied from the vertical scanning circuit unit 40 (or the horizontal scanning circuit unit 60) to the other input node of the NAND circuit LC2. An output node of the NAND circuit LC3 is connected to the input node of the counter circuit 34 (not illustrated in FIG. 13).

The waveform shaping circuit 32 outputs a second value when the control signal P1 is at a first level, and outputs a first value when the control signal P1 is at a second level different from the first level and the APD is in a discharge state in which avalanche multiplication does not occur. The waveform shaping circuit 32 holds the output value when the control signal P1 is at the second level and the APD is in the standby state in which avalanche multiplication can be performed. The first level is, for example, low-level, and the second level is, for example, high-level. The first value is, for example, 1 (high-level), and the second value is, for example, 0 (low-level). Next, an operation of the photoelectric conversion device according to the

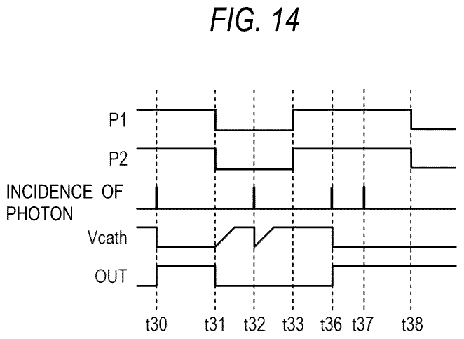

present embodiment will be described with reference to FIG. 14 to FIG. 16. FIG. 14 is a timing chart of an ideal state in which no phase difference occurs between the control signal P1 and the control signal P2. FIG. 15 is a timing chart when a phase difference occurs between the control signal P1 and the control signal P2. FIG. 16 is a timing chart when the cathode voltage Vcath is affected by a disturbance. In either case, in the initial state before time t0, the control signals P1 and P2 and the cathode voltage Vcath are at high-level, and the output OUT is at low-level. The p-channel MOS transistor Mq is turned off in response to the control signal P2 at high-level, and operates in the quench operation mode. In addition, the waveform shaping circuit 32 is in a standby state in which the value of the output OUT changes according to the cathode voltage Vcath of the APD upon receiving the control signal P1 of high-level.

First, an operation in an ideal state in which no phase difference occurs between the control signal P1 and the control signal P2 will be described with reference to FIG. 14.

At time t30, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t31, the control signal P1 transits from high-level to low-level, whereby the waveform shaping circuit 32 enters the reset state, and the signal level of the output OUT transits from high-level to low-level. Similarly, at time t31, the control signal P2 transitions from high-level to low-level. As a result, the p-channel MOS transistor Mq is turned on in response to the control signal P2 at low-level, and shifts to the recharge operation mode. As a result, the APD is charged, and the cathode voltage Vcath returns to the voltage VH.

In the period in which the control signals P1 and P2 are at low-level, the signal level of the output OUT of the waveform shaping circuit 32 is maintained at low-level even if a photon is incident. For example, when a photon is incident at time t32, the cathode voltage Vcath decreases due to avalanche multiplication by the incident photon, but is recharged and returns to the voltage VH as soon as the avalanche multiplication stops. The output OUT of the waveform shaping circuit 32 receives the control signal P1 at low-level, and is maintained at low-level regardless of the change in the cathode voltage Vcath.

At the subsequent time t33, the control signals P1 and P2 transition from low-level to high-level. As a result, the p-channel MOS transistor Mq enters the quench operation mode again, and the waveform shaping circuit 32 is released from the reset state and returns to the standby state.

When a photon enters the photoelectric conversion element 22 at the subsequent time t36, the cathode voltage Vcath decreases due to avalanche multiplication in the APD, and the output OUT of the waveform shaping circuit 32 transitions from low-level to high-level.

After the photon is detected once in the period in which the control signals P1 and P2 are at high-level, even if the photon is incident again, the signal level of the output OUT of the waveform shaping circuit 32 is maintained at high-level. For example, even if a photon is incident at time t37, avalanche multiplication does not occur because the APD is not recharged. Therefore, the output OUT of the waveform shaping circuit 32 is maintained at high-level.

As described above, in an ideal state in which no phase difference occurs between the control signal P1 and the control signal P2, the avalanche multiplication generated during one cycle of the control signals P1 and P2 can be counted only once. In the driving example of FIG. 14, the length of one cycle of the control signals P1 and P2 corresponds to, for example, the length of a period from time t31 to time t38.

Next, an operation when a phase difference occurs between the control signal P1 and the control signal P2 will be described with reference to FIG. 15. Here, it is assumed that the control signal P2 is delayed with respect to the control signal P1.

At time t30, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t31a, the control signal P1 transits from high-level to low-level, whereby the waveform shaping circuit 32 enters the reset state, and the signal level of the output OUT transits from high-level to low-level.

At the subsequent time t31b, it is assumed that the control signal P2 transitions from high-level to low-level later than the transition of the control signal P1. As a result, the p-channel MOS transistor Mq is turned on in response to the control signal P2 at low-level, and shifts to the recharge operation mode. As a result, the APD is recharged, and the cathode voltage Vcath returns to the voltage VH.

At the subsequent time t33a, the control signal P1 transitions from low-level to high-level. As a result, the waveform shaping circuit 32 is released from the reset state and returns to the standby state, but since the control signal P2 is at low-level, the p-channel MOS transistor Mq remains in the recharge operation mode. As a result, for example, when a photon is incident on the pixel 12 at the subsequent time t34, the cathode voltage Vcath decreases due to avalanche multiplication in the APD, the waveform shaping circuit 32 is in the set state, and the output OUT transitions from low-level to high-level. The counter circuit 34 in the subsequent stage counts the state transition of the output OUT from low-level to high-level, and increments the count value by one. Thereafter, the cathode voltage Vcath is recharged, but the set state of the waveform shaping circuit 32 is maintained.

At the subsequent time t33b, when the control signal P2 transitions from low-level to high-level, the p-channel MOS transistor Mq returns to the quench operation mode.

When a photon enters the photoelectric conversion element 22 at the subsequent time t36, the cathode voltage Vcath decreases due to avalanche multiplication in the APD. However, at this time, the waveform shaping circuit 32 is already in the set state, and the output OUT is maintained at high-level.

Even if a photon is incident again after time t36, the signal level of the output OUT of the waveform shaping circuit 32 is maintained at high-level. For example, even if a photon is incident at time t37, avalanche multiplication does not occur because the APD is not recharged. Therefore, the output OUT of the waveform shaping circuit 32 is maintained at high-level.

As described above, even in a state where a phase difference is generated between the control signal P1 and the control signal P2, the avalanche multiplication generated during one cycle of the control signals P1 and P2 can be counted only once. In the driving example of FIG. 15, the length of one cycle of the control signal P1 corresponds to, for example, the length of the period from the time t31a to the time t38a. The length of one cycle of the control signal P2 corresponds to, for example, the length of the period from the time t3 1b to the time t38b.

Next, an operation when the cathode voltage Vcath is affected by a disturbance will be described with reference to FIG. 16.

At time t30, it is assumed that a photon is incident on the pixel 12 in the above-described initial state. When a photon enters the photoelectric conversion element 22, avalanche multiplication occurs in the APD using the electron-hole pair generated by photoelectric conversion as seeds, and the cathode voltage Vcath of the APD decreases. As a result, the signal level of the output OUT of the waveform shaping circuit 32 transitions from low-level to high-level. The counter circuit 34 in the subsequent stage counts the state transition of the output OUT from low-level to high-level, and increments the count value by one.

At the subsequent time t31, the control signal P1 transits from high-level to low-level, whereby the waveform shaping circuit 32 enters the reset state, and the signal level of the output OUT transits from high-level to low-level. Similarly, at time 31, the control signal P2 transitions from high-level to low-level. As a result, the p-channel MOS transistor Mq is turned on in response to low-level control signal, and shifts to the recharge operation mode. As a result, the APD is recharged, and the cathode voltage Vcath returns to the voltage VH.

In the period in which the control signals P1 and P2 are at low-level, the signal level of the output OUT of the waveform shaping circuit 32 is maintained at low-level even if a photon is incident. For example, when a photon is incident at time t32, the cathode voltage Vcath decreases due to avalanche multiplication by the incident photon, but when the avalanche multiplication stops, the APD starts to be recharged. The output OUT of the waveform shaping circuit 32 receives the control signal P1 at low-level, and is maintained at low-level regardless of the change in the cathode voltage Vcath.

At the subsequent time t33, the control signal P1 transitions from low-level to high-level, and the control signal P2 transitions from low-level to high-level. As a result, the p-channel MOS transistor Mq enters the quench operation mode again, and the waveform shaping circuit 32 returns to the standby state in which the value of the output OUT changes in accordance with the cathode voltage Vcath again.

When the photon incidence timing (time t32) is just before the end of the recharge period (period from time t31 to time t33), the recharge period of the APD cannot be sufficiently secured, and the cathode voltage Vcath may not return to the voltage VH. In this case, the operation of recharging the cathode voltage Vcath stops at an intermediate potential between the voltage VL and the voltage VH.

If the increase of the cathode voltage Vcath stops near the logical threshold value of the waveform shaping circuit 32, the cathode voltage Vcath may change across the logical threshold value when the cathode voltage Vcath fluctuates due to a disturbance. For example, when a disturbance occurs in the cathode terminal of the APD at time t35 and the cathode voltage Vcath fluctuates across the logical threshold value, chattering as described in the second embodiment may occur.

However, when the cathode voltage Vcath exceeds the logical threshold value even once and enters the set state, the waveform shaping circuit 32 thereafter maintains the set state irrespective of the cathode voltage Vcath. Therefore, even if a disturbance enters the cathode terminal of the APD and the cathode voltage Vcath fluctuates, the influence of the disturbance is not transmitted to the output OUT of the waveform shaping circuit 32.

When a photon enters the photoelectric conversion element 22 at the subsequent time t36, the cathode voltage Vcath decreases due to avalanche multiplication in the APD. However, at this time, the waveform shaping circuit 32 is already in the set state, and the output OUT is maintained at high-level.

Even if a photon is incident again after time t36, the signal level of the output OUT of the waveform shaping circuit 32 is maintained at high-level. For example, even if a photon is incident at time t37, avalanche multiplication does not occur because the APD is not recharged. Therefore, the output OUT of the waveform shaping circuit 32 is maintained at high-level.

As described above, even when the cathode voltage Vcath is affected by a disturbance, the avalanche multiplication generated during one cycle of the control signals P1 and P2 can be counted only once. In the driving example of FIG. 16, the length of one cycle of the control signals P1 and P2 corresponds to, for example, the length of the period from time t31 to time t38.

As described above, according to the present embodiment, when the number of periods in which avalanche multiplication occurs is counted among a plurality of periods in which the APD is controlled to the standby state in which avalanche multiplication is possible, the number of periods in which avalanche multiplication occurs may be accurately counted.

### Fourth Embodiment

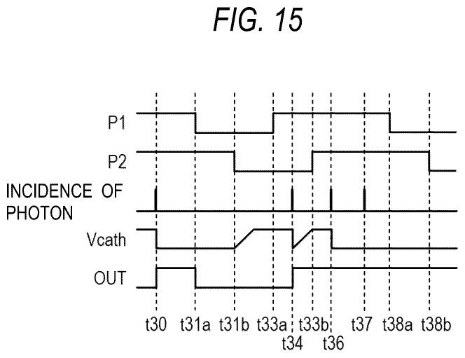

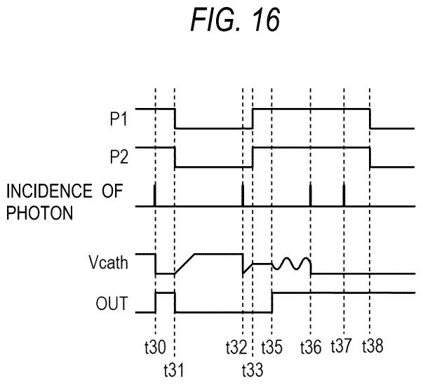

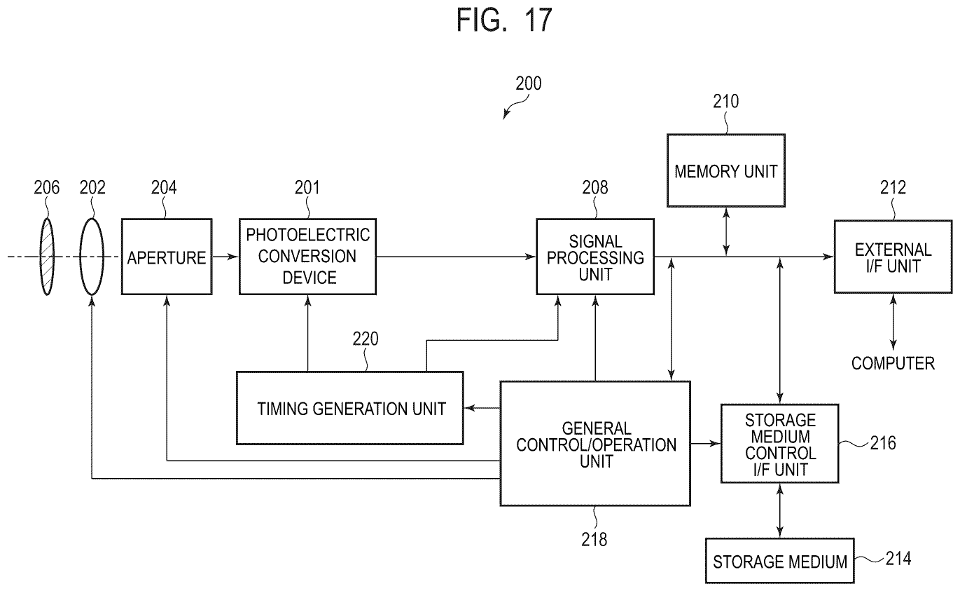

A photodetection system according to a fourth embodiment of the present invention will be described with reference to FIG. 17. FIG. 17 is a block diagram illustrating a schematic configuration of a photodetection system according to the present embodiment. In the present embodiment, a photodetection sensor to which the photoelectric conversion device 100 according to any of the first to third embodiments is applied will be described.

The photoelectric conversion device 100 described in the first to third embodiments may be applied to various photodetection systems. Examples of applicable photodetection systems include imaging systems such as digital still cameras, digital camcorders, surveillance cameras, copying machines, facsimiles, mobile phones, on-vehicle cameras, observation satellites, and the like. A camera module including an optical system such as a lens and an imaging device is also included in the photodetection system. FIG. 17 exemplifies a block diagram of a digital still camera as one of these.

The photodetection system 200 illustrated in FIG. 17 includes a photoelectric conversion device 201, a lens 202 that forms an optical image of an object on the photoelectric conversion device 201, an aperture 204 that changes an amount of light passing through the lens 202, and a barrier 206 that protects the lens 202. The lens 202 and the aperture 204 form an optical system that focuses light onto the photoelectric conversion device 201. The photoelectric conversion device 201 is the photoelectric conversion device 100 described in any of the first to third embodiments, and converts the optical image formed by the lens 202 into image data.

The photodetection system 200 further includes a signal processing unit 208 that processes an output signal output from the photoelectric conversion device 201. The signal processing unit 208 generates image data from the digital signal output from the photoelectric conversion device 201. Further, the signal processing unit 208 performs various corrections and compressions as necessary and outputs the processed image data. The photoelectric conversion device 201 may include an AD conversion unit that generates a digital signal to be processed by the signal processing unit 208. The AD conversion unit may be formed on a semiconductor layer (semiconductor substrate) on which the photoelectric conversion element of the photoelectric conversion device 201 is formed, or may be formed on a semiconductor layer different from the semiconductor layer on which the photoelectric conversion element of the photoelectric conversion device 201 is formed. The signal processing unit 208 may be formed on the same semiconductor layer as the photoelectric conversion device 201.

The photodetection system 200 further includes a memory unit 210 for temporarily storing image data and an external interface unit (external I/F unit) 212 for communicating with an external computer or the like. Further, the photodetection system 200 includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photodetection system 200 or may be detachable. Communication between the storage medium control I/F unit 216 and the storage medium 214 and communication from the external I/F unit 212 may be performed wirelessly.

The photodetection system 200 further includes a general control/operation unit 218 that performs various calculations and controls the entire digital still camera, and a timing generation unit 220 that outputs various timing signals to the photoelectric conversion device 201 and the signal processing unit 208. Here, the timing signal or the like may be input from the outside, and the photodetection system 200 may include at least the photoelectric conversion device 201 and the signal processing unit 208 that processes the output signal output from the photoelectric conversion device 201. The timing generation unit 220 may be mounted on the photoelectric conversion device 201. Further, the general control/operation unit 218 and the timing generation unit 220 may be configured to perform a part or all of the control functions of the photoelectric conversion device 201.

The photoelectric conversion device 201 outputs an imaging signal to the signal processing unit 208. The signal processing unit 208 performs predetermined signal processing on the imaging signal output from the photoelectric conversion device 201, and outputs the processed image data. The signal processing unit 208 generates an image using the imaging signal. The signal processing unit 208 may be configured to perform distance measurement calculation on the signal output from the photoelectric conversion device 201.

As described above, according to the present embodiment, by configuring the photodetection system using the photoelectric conversion devices according to any of the first to third embodiments, it is possible to realize the photodetection system capable of acquiring a higher quality image.

### Fifth Embodiment

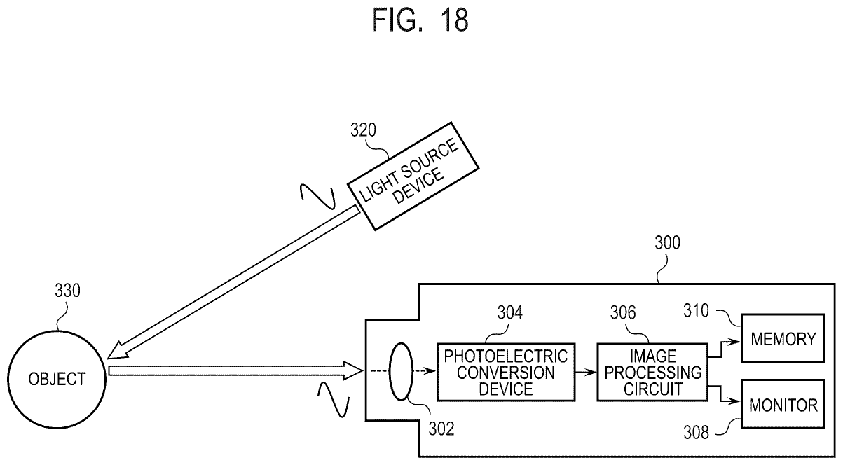

A range image sensor according to a fifth embodiment of the present invention will be described with reference to FIG. 18. FIG. 18 is a block diagram illustrating a schematic configuration of a range image sensor according to the present embodiment. In the present embodiment, a range image sensor will be described as an example of a photodetection system to which the photoelectric conversion device 100 according to any of the first to third embodiments are applied.

As illustrated in FIG. 18, the range image sensor 300 according to the present embodiment may include an optical system 302, a photoelectric conversion device 304, an image processing circuit 306, a monitor 308, and a memory 310. The range image sensor 300 receives light (modulated light or pulsed light) emitted from a light source device 320 toward an object 330 and reflected on the surface of the object 330, and acquires a distance image corresponding to the distance to the object 330.

The optical system 302 includes one or a plurality of lenses, and has a function of forming an image of image light (incident light) from the object 330 on a light receiving surface (sensor unit) of the photoelectric conversion device 304.

The photoelectric conversion device 304 is the photoelectric conversion device 100 described in any of the first to third embodiments, and has a function of generating a distance signal indicating a distance to the object 330 based on image light from the object 330 and supplying the generated distance signal to the image processing circuit 306.

The image processing circuit 306 has a function of performing image processing for constructing a distance image based on the distance signal supplied from the photoelectric conversion device 304.

The monitor 308 has a function of displaying a distance image (image data) obtained by image processing in the image processing circuit 306. The memory 310 has a function of storing (recording) a distance image (image data) obtained by image processing in the image processing circuit 306.

As described above, according to the present embodiment, by configuring the range image sensor using the photoelectric conversion devices according to any of the first to third embodiments, it is possible to realize a range image sensor capable of acquiring a range image including more accurate range information in conjunction with improvement in characteristics of the pixels 12.

### Sixth Embodiment

An endoscopic surgical system according to a sixth embodiment of the present invention will be described with reference to FIG. 19.

FIG. 19 is a schematic diagram illustrating a configuration example of an endoscopic surgical system according to the present embodiment. In the present embodiment, an endoscopic surgical system will be described as an example of a photodetection system to which the photoelectric conversion devices 100 according to any of the first to third embodiments are applied.

FIG. 19 illustrates a state in which an operator (surgeon) 460 performs surgery on a patient 472 on a patient bed 470 using an endoscopic surgical system 400.

As illustrated in FIG. 16, the endoscopic surgical system 400 according to the present embodiment may include an endoscope 410, a surgical tool 420, and a cart 430 on which various devices for endoscopic surgery are mounted. A CCU (Camera Control Unit) 432, a light source device 434, an input device 436, a processing tool control device 438, a display device 440, and the like may be mounted on the cart 430.

The endoscope 410 includes a lens barrel 412 in which an area of a predetermined length from the tip is inserted into a body cavity of the patient 472, and a camera head 414 connected to the base end of the lens barrel 412. Although FIG. 16 illustrates an endoscope 410 configured as a so-called rigid mirror having a rigid lens barrel 412, the endoscope 410 may be configured as a so-called flexible mirror having a flexible lens barrel. The endoscope 410 is held in a movable state by an arm 416.

The tip of the lens barrel 412 is provided with an opening into which the objective lens is fitted. A light source device 434 is connected to the endoscope 410, and light generated by the light source device 434 is guided to the tip of a lens barrel 412 by a light guide extended inside the lens barrel, and is irradiated toward an observation target in the body cavity of the patient 472 through the objective lens. Note that the endoscope 410 may be a direct-viewing mirror, an oblique-viewing mirror, or a side-viewing mirror.

An optical system and a photoelectric conversion device (not illustrated) are provided inside the camera head 414, and reflected light (observation light) from the observation target is focused on the photoelectric conversion device by the optical system.

The photoelectric conversion device photoelectrically converts the observation light and generates an electrical signal corresponding to the observation light, that is, an image signal corresponding to the observation image. As the photoelectric conversion device, the photoelectric conversion device 100 described in any of the first to third embodiments may be used. The image signal is transmitted to the CCU 432 as RAW data.

The CCU 432 may be configured by a CPU (Central Processing Unit), a GPU (Graphics Processing Unit), or the like, and integrally controls operations of the endoscope 410 and the display device 440. Further, the CCU 432 receives an image signal from the camera head 414, and performs various types of image processing for displaying an image based on the image signal, such as development processing (demosaic processing), on the image signal.

The display device 440 displays an image based on the image signal subjected to the image processing by the CCU 432 under the control of the CCU 432.

The light source device 434 may be configured by, for example, a light source such as an LED (Light Emitting Diode), and supplies irradiation light to the endoscope 410 when photographing a surgical part or the like.

The input device 436 is an input interface to the endoscopic surgical system 400.

The user may input various kinds of information and input instructions to the endoscopic surgical system 400 via the input device 436.

The processing tool control device 438 controls the driving of the energy processing tool 450 for tissue ablation, incision, blood vessel sealing, or the like.

The light source device 434 that supplies irradiation light to the endoscope 410 when imaging the surgical part may be configured by, for example, a white light source configured by an LED, a laser light source, or a combination thereof. When the white light source is configured by a combination of the RGB laser light sources, since the output intensity and the output timing of each color (each wavelength) may be controlled with high accuracy, the white balance of the captured image may be adjusted in the light source device 434. In addition, in this case, it is also possible to capture an image corresponding to each of RGB in a time division manner by irradiating the observation target with laser light from each of the RGB laser light sources in a time division manner and controlling driving of the imaging element of the camera head 414 in synchronization with the irradiation timing. According to this method, a color image may be obtained without providing a color filter in the image sensor.

Further, the driving of the light source device 434 may be controlled so as to change the intensity of light to be output every predetermined time. By controlling the driving of the image sensor of the camera head 414 in synchronization with the timing of the change of the intensity of the light to acquire an image in a time-division manner and synthesizing the image, it is possible to generate an image having a high dynamic range free from so-called blacked up shadows and blown out highlights.

The light source device 434 may be configured to be capable of supplying light in a predetermined wavelength band corresponding to special light observation. In the special light observation, for example, wavelength dependency of absorption of light in body tissue is utilized. Specifically, a predetermined tissue such as a blood vessel in the superficial layer of a mucous membrane is photographed with high contrast by irradiating light in a narrow band as compared with irradiation light (that is, white light) at the time of normal observation. Alternatively, in the special light observation, fluorescence observation in which an image is obtained by fluorescence generated by irradiation with excitation light may be performed. In the fluorescence observation, a body tissue is irradiated with excitation light to observe fluorescence from the body tissue, or a body tissue is locally injected with a reagent such as indocyanine green (ICG), and the body tissue is irradiated with excitation light corresponding to a fluorescence wavelength of the reagent to obtain a fluorescence image. The light source device 434 may be configured to be capable of supplying narrowband light and/or excitation light corresponding to such special light observation.

As described above, according to the present embodiment, by configuring the endoscopic surgical system using the photoelectric conversion devices according to any of the first to third embodiments, it is possible to realize an endoscopic surgical system capable of acquiring a better quality image.

### Seventh Embodiment

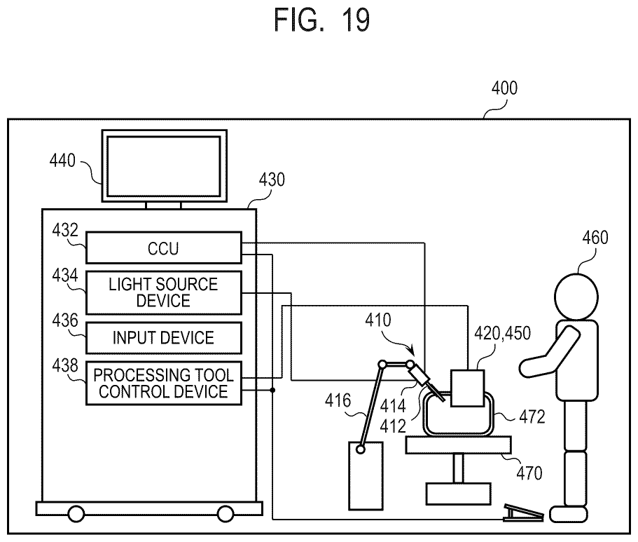

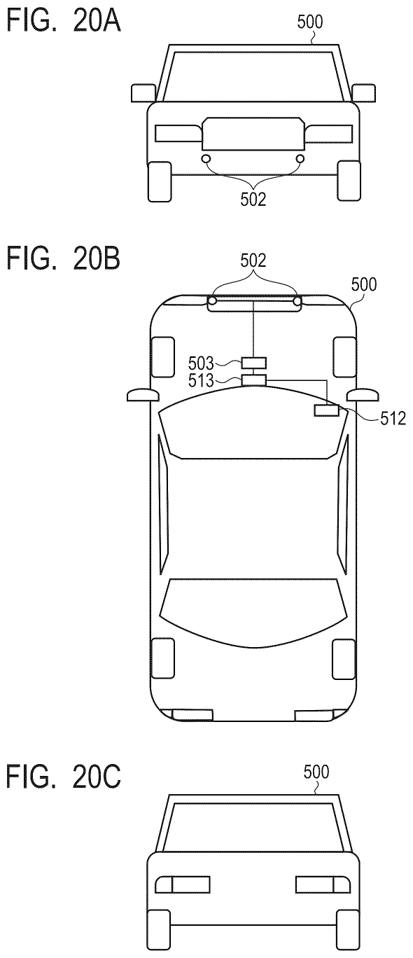

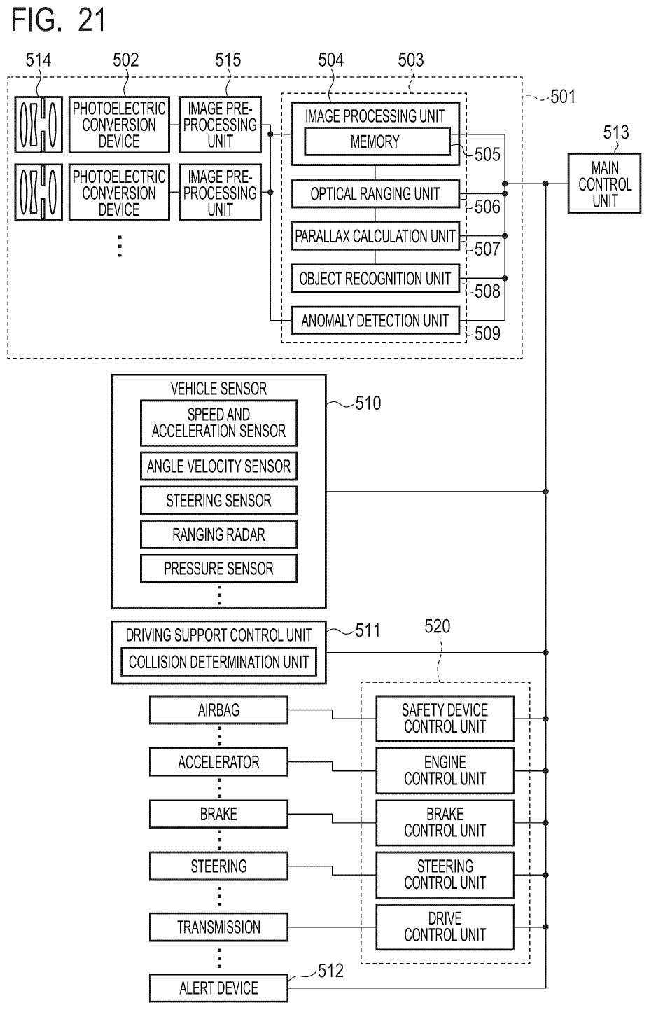

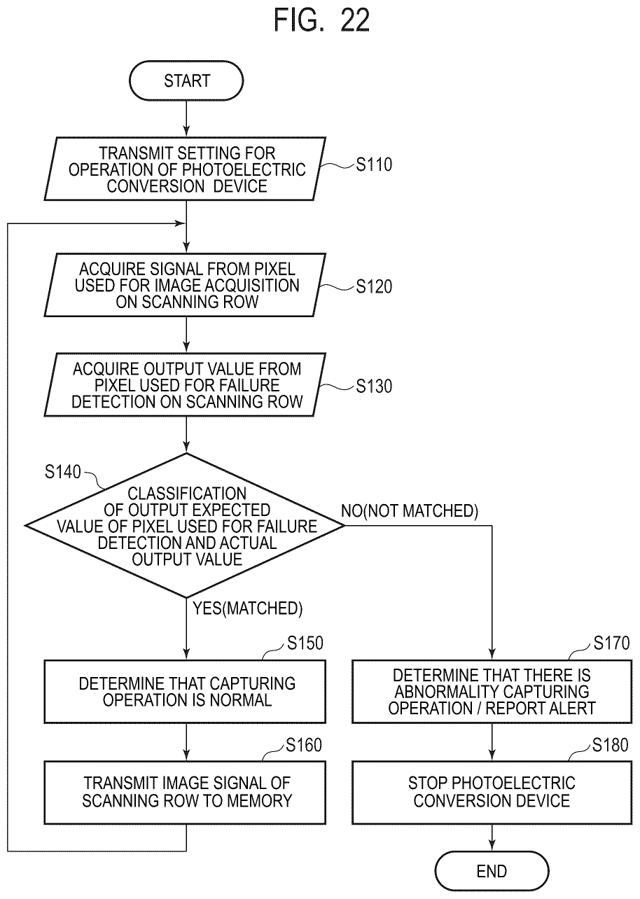

A photodetection system and a movable object according to a seventh embodiment of the present invention will be described with reference to FIG. 20A to FIG. 22. FIG. 20A to FIG. 20C are schematic diagrams illustrating a configuration example of a mobile object according to the present embodiment. FIG. 21 is a block diagram illustrating a schematic configuration of a photodetection system according to the present embodiment. FIG. 22 is a flowchart illustrating an operation of the photodetection system according to the present embodiment. In the present embodiment, an application example to an on-vehicle camera will be described as a photodetection system to which the photoelectric conversion devices 100 according to any of the first to third embodiments are applied.

FIG. 20A to FIG. 20C are schematic diagrams illustrating a configuration example of a movable object (vehicle system) according to the present embodiment. FIG. 20A to FIG. 20C illustrate a configuration of a vehicle 500 (automobile) as an example of a vehicle system incorporating a photodetection system to which the photoelectric conversion devices according to any of the first to third embodiments are applied. FIG. 20A is a schematic front view of the vehicle 500, FIG. 20B is a schematic plan view of the vehicle 500, and FIG. 20C is a schematic rear view of the vehicle 500. The vehicle 500 includes a pair of photoelectric conversion devices 502 on a front surface thereof. Here, the photoelectric conversion device 502 is the photoelectric conversion device 100 described in any of the first to third embodiments. The vehicle 500 includes an integrated circuit 503, an alert device 512, and a main control unit 513.

FIG. 21 is a block diagram illustrating a configuration example of the photodetection system 501 mounted on the vehicle 500. The photodetection system 501 includes photoelectric conversion devices 502, image preprocessing units 515, an integrated circuit 503, and optical systems 514. The photoelectric conversion device 502 is the photoelectric conversion device 100 described in any of the first to third embodiments. The optical system 514 forms an optical image of an object on the photoelectric conversion device 502. The photoelectric conversion device 502 converts the optical image of the object formed by the optical system 514 into an electrical signal. The image preprocessing unit 515 performs predetermined signal processing on the signal output from the photoelectric conversion device 502. The function of the image preprocessing unit 515 may be incorporated in the photoelectric conversion device 502. At least two sets of the optical system 514, the photoelectric conversion device 502, and the image preprocessing unit 515 are provided in the photodetection system 501, and an output from each set of the image preprocessing unit 515 is input to the integrated circuit 503.

The integrated circuit 503 is an integrated circuit for an imaging system application, and includes an image processing unit 504, an optical ranging unit 506, a parallax calculation unit 507, an object recognition unit 508, and an abnormality detection unit 509. The image processing unit 504 processes the image signal output from the image preprocessing unit 515. For example, the image processing unit 504 performs image processing such as development processing and defect correction on the output signal of the image preprocessing unit 515. The image processing unit 504 includes a memory 505 that temporarily holds the image signal. In the memory 505, for example, the position of a known defective pixel in the photoelectric conversion device 502 may be stored.

The optical ranging unit 506 performs focusing and distance measurement of the object. The parallax calculation unit 507 calculates distance measurement information (distance information) from a plurality of image data (parallax images) acquired by the plurality of photoelectric conversion devices 502. Each of the photoelectric conversion devices 502 may have a configuration capable of acquiring various kinds of information such as distance information. The object recognition unit 508 recognizes an object such as a vehicle, a road, a sign, or a person.

Upon detecting an abnormality in the photoelectric conversion device 502, the abnormality detection unit 509 notifies the main control unit 513 of the abnormality.

The integrated circuit 503 may be realized by dedicatedly designed hardware, may be realized by a software module, or may be realized by a combination thereof. Further, it may be realized by FPGA (Field Programmable Gate Array), ASIC (Application Specific Integrated Circuit), or the like, or may be realized by a combination of these.

The main control unit 513 integrally controls the operations of the photodetection system 501, the vehicle sensor 510, the control unit 520, and the like. The vehicle 500 may not include the main control unit 513.

In this case, the photoelectric conversion device 502, the vehicle sensor 510, and the control unit 520 transmit and receive control signals via a communication network. For example, the CAN (Controller Area Network) standard may be applied to the transmission and reception of the control signals.

The integrated circuit 503 has a function of receiving a control signal from the main control unit 513 or transmitting a control signal or a setting value to the photoelectric conversion device 502 by its own control unit.

The photodetection system 501 is connected to the vehicle sensor 510, and may detect a traveling state of the host vehicle such as a vehicle speed, a yaw rate, and a steering angle, an environment outside the host vehicle, and states of other vehicles and obstacles.

The vehicle sensor 510 is also a distance information acquisition unit that acquires distance information to the object. In addition, the photodetection system 501 is connected to a driving support control unit 511 that performs various kinds of driving support such as automatic steering, automatic traveling, and a collision prevention function. In particular, with respect to the collision determination function, the driving support control unit 511 estimates the collision with other vehicles or obstacles and determines whether or not there is a collision with other vehicles or obstacles based on the detection results of the photodetection system 501 and the vehicle sensor 510. Thus, avoidance control when a collision is estimated and activation of the safety device at the time of the collision are performed.

The photodetection system 501 is also connected to an alert device 512 that issues an alert to the driver based on the determination result of the collision determination unit. For example, when the determination result of the collision determination unit is that the possibility of a collision is high, the main control unit 513 performs vehicle control for avoiding a collision and reducing damage by applying a brake, returning an accelerator, suppressing engine output, or the like. The alert device 512 alerts the user by sounding an alarm such as a sound, displaying alert information on a display screen of a car navigation system, a meter panel, or the like, or vibrating a seat belt or a steering wheel.

In the present embodiment, an image of the surroundings of the vehicle, for example, the front or the rear, is captured by the photodetection system 501. FIG. 20B illustrates an arrangement example of the photodetection system 501 in a case where the photodetection system 501 captures an image in front of the vehicle.

As described above, the photoelectric conversion devices 502 are disposed in front of the vehicle 500. Specifically, it is preferable that a center line with respect to an advancing/retreating direction or an outer shape (for example, a vehicle width) of the vehicle 500 is regarded as a symmetry axis, and two photoelectric conversion devices 502 are disposed line-symmetrically with respect to the symmetry axis in order to acquire distance information between the vehicle 500 and an object to be imaged and determine a possibility of collision. In addition, the photoelectric conversion devices 502 are preferably disposed so as not to interfere with the driver's visual field when the driver visually recognizes a situation outside the vehicle 500 from the driver's seat. The alert device 512 is preferably disposed so as to easily enter the field of view of the driver.

Next, a failure detection operation of the photoelectric conversion device 502 in the photodetection system 501 will be described with reference to FIG. 22. The failure detection operation of the photoelectric conversion device 502 may be performed in accordance with steps S110 to S180 illustrated in FIG. 22.

Step S110 is a step of performing setting at the time of start-up of the photoelectric conversion device 502. That is, the setting for the operation of the photoelectric conversion device 502 is transmitted from the outside of the photodetection system 501 (for example, the main control unit 513) or the inside of the photodetection system 501, and the imaging operation and the failure detection operation of the photoelectric conversion device 502 are started.

Next, in step S120, pixel signals are acquired from the effective pixels. In step S130, an output value from a failure detection pixel provided for failure detection is acquired. The failure detection pixel may include a photoelectric conversion element in the same manner as the effective pixel. A predetermined voltage is written to the photoelectric conversion element of the failure detection pixel. The failure detection pixel outputs a signal corresponding to the voltage written in the photoelectric conversion element. Note that step S120 and step S130 may be reversed.

Next, in step S140, a classification of the output expected value of the failure detection pixel and the actual output value from the failure detection pixel is performed. As a result of the classification in step S140, when the output expected value matches the actual output value, the process proceeds to step S150, it is determined that the imaging operation is normally performed, and the process step proceeds to step S160. In step S160, the pixel signals of the scanning row are transmitted to the memory 505 and temporarily stored. After that, the process returns to step S120 to continue the failure detection operation. On the other hand, as a result of the classification in step S140, when the output expected value does not coincide with the actual output value, the process proceeds to step S170. In step S170, it is determined that there is an abnormality in the imaging operation, and an alert is notified to the main control unit 513 or the alert device 512. The alert device 512 causes the display unit to display that an abnormality has been detected. Thereafter, in step S180, the photoelectric conversion device 502 is stopped, and the operation of the photodetection system 501 is ended.

In the present embodiment, an example in which the flowchart is looped for each row is described, but the flowchart may be looped for each plurality of rows, or the failure detection operation may be performed for each frame. The alert of step S170 may be notified to the outside of the vehicle via a wireless network.

In addition, in the present embodiment, the control in which the own vehicle does not collide with another vehicle has been described, but the present invention is also applicable to control in which the own vehicle follows another vehicle and performs automatic driving, control in which the vehicle performs automatic driving so as not to protrude from a lane, and the like. Further, the photodetection system 501 is not limited to a vehicle such as an own vehicle, and may be applied to, for example, other movable object (mobile device) of a ship, an aircraft, an industrial robot, or the like. In addition, the present invention is not limited to the movable object, and may be widely applied to equipment using object recognition, such as ITS (Intelligent Transport Systems).

### Eighth Embodiment

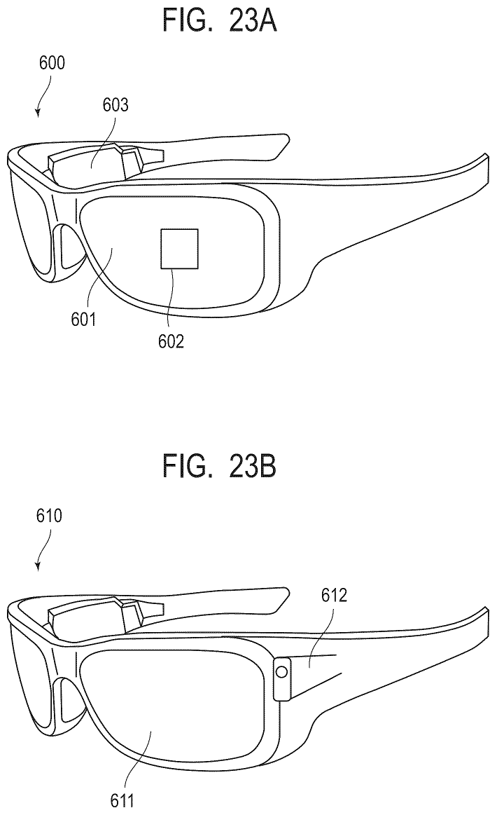

A photodetection system according to an eighth embodiment of the present invention will be described with reference to FIG. 23A and FIG. 23B. FIG. 23A and FIG. 23B are schematic diagrams illustrating a configuration example of a photodetection system according to the present embodiment. In the present embodiment, an application example to eyeglasses (smartglasses) will be described as a photodetection system to which the photoelectric conversion devices 100 according to any of the first to third embodiments are applied.

FIG. 23A illustrates eyeglasses 600 (smartglasses) according to one application example. The eyeglasses 600 include lenses 601, a photoelectric conversion device 602, and a control device 603.

The photoelectric conversion device 602 is the photoelectric conversion device 100 described in any of the first to third embodiments, and is provided on the lens 601. One photoelectric conversion device 602 may be provided, or a plurality of photoelectric conversion devices may be provided. When a plurality of photoelectric conversion devices 602 are used, a combination of a plurality of types of photoelectric conversion devices 602 may be used. The arrangement position of the photoelectric conversion device 602 is not limited to FIG. 23A. A display device (not illustrated) including a light emitting device such as an OLED (Organic Light Emitting Diode) or an LED (Light Emitting Diode) may be provided on the back surface side of the lens 601.

The control device 603 functions as a power supply that supplies power to the photoelectric conversion device 602 and the display device. The control device 603 has a function of controlling the operations of the photoelectric conversion device 602 and the display device. The lens 601 may be provided with an optical system for focusing light on the photoelectric conversion device 602.

FIG. 23B illustrates eyeglasses 610 (smartglasses) according to another application example. The eyeglasses 610 include lenses 611 and a control device 612. A photoelectric conversion device (not illustrated) corresponding to the photoelectric conversion device 602 and the display device may be mounted on the control device 612.

The lens 611 is provided with a photoelectric conversion device in the control device 612 and an optical system for projecting light from the display device, and an image is projected thereon. The control device 612 functions as a power supply that supplies power to the photoelectric conversion device and the display device, and has a function of controlling operations of the photoelectric conversion device and the display device.

The control device 612 may further include a line-of-sight detection unit that detects the line of sight of the wearer. In this case, an infrared light emitting unit may be provided in the control device 612, and infrared light emitted from the infrared light emitting unit may be used for detection of a line of sight. Specifically, the infrared light emitting unit emits infrared light to the eyeball of the user who is watching the display image. A captured image of the eyeball is obtained by detecting reflected light of the emitted infrared light from the eyeball by an imaging unit having a light receiving element. By providing a reduction unit that reduces light from the infrared light emitting unit to the display unit in a plan view, it is possible to reduce degradation of image quality.

The line of sight of the user with respect to the display image may be detected from the captured image of the eyeball obtained by capturing the infrared light. Any known technique can be applied to the line-of-sight detection using the captured image of the eyeball. As an example, a line-of-sight detection method based on a Purkinje image due to reflection of irradiation light on the cornea may be used. More specifically, the line-of-sight detection process based on the pupil corneal reflection method is performed. The line of sight of the user may be detected by calculating a line-of-sight vector representing the orientation (rotation angle) of the eyeball based on the image of the pupil included in the captured image of the eyeball and the Purkinje image using the pupil corneal reflex method.

The display device according to the present embodiment may include a photoelectric conversion device having a light receiving element, and may be configured to control a display image based on line-of-sight information of a user from the photoelectric conversion device. Specifically, the display device determines, based on the line-of-sight information, a first viewing area that the user gazes at and a second viewing area other than the first viewing area. The first viewing area and the second viewing area may be determined by a control device of the display device, or may be determined by an external control device. When the determination is made by the external control device, the determination result is transmitted to the display device via communication. In the display area of the display device, the display resolution of the first viewing area may be controlled to be higher than the display resolution of the second viewing area. That is, the resolution of the second viewing area may be lower than the resolution of the first viewing area.

The display area may include a first display area and a second display area different from the first display area, and an area having a high priority may be determined from the first display area and the second display area based on the line-of-sight information. The first display area and the second display area may be determined by a control device of the display device or may be determined by an external control device. When the determination is made by the external control device, the determination result is transmitted to the display device via communication. The resolution of the high priority area may be controlled to be higher than the resolution of the area other than the high priority area. That is, the resolution of the area having a relatively low priority may be lowered.

Note that the AI (Artificial Intelligence) may be used to determine the first viewing area or the area with a high priority. The AI may be a model configured to estimate an angle of the line of sight and a distance to a target object ahead of the line of sight from the image of the eyeball using the image of the eyeball and the direction in which the eyeball of the image is actually viewed as teacher data. The AI program may be included in the display device, the photoelectric conversion device, or the external device. When the external device has the program, information is transmitted to the display device via communication.

In the case of performing display control based on visual recognition detection, the present invention may be preferably applied to smartglasses further including a photoelectric conversion device that captures an image of the outside. Smartglasses may display captured external information in real time.

### Ninth Embodiment

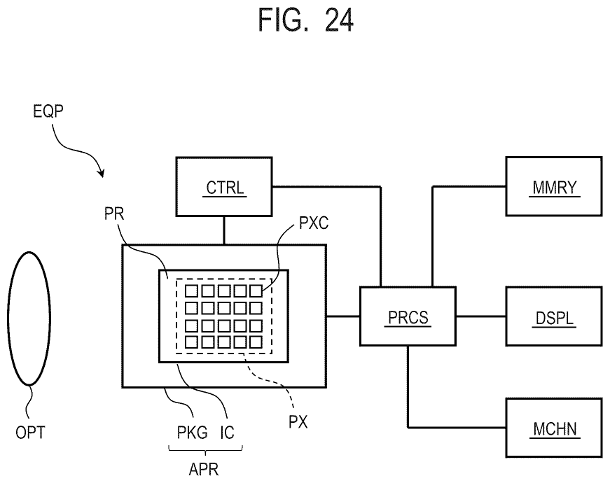

Equipment according to a ninth embodiment of the present invention will be described with reference to FIG. 24. FIG. 24 is a block diagram illustrating a schematic configuration of equipment according to the present embodiment.

FIG. 24 is a schematic diagram illustrating equipment EQP including a photoelectric conversion device APR. The photoelectric conversion device APR has the function of the photoelectric conversion device 100 according to any of the first to third embodiments. All or part of the photoelectric conversion device APR is a semiconductor device IC. The photoelectric conversion device APR of the present example may be used as, for example, an image sensor, an AF (Auto Focus) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be disposed in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be column circuits corresponding to pixel columns of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (TSV (Through Silicon Via)), an inter-chip interconnection by direct bonding of a conductor such as copper, a connection by a micro bump between the chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided in the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR, and constitutes an AFE (Analog Front End) or a DFE (Digital Front End). The processing unit PRCS is a semiconductor device such as a CPU (Central Processing Unit) or an ASIC (Application Specific Integrated Circuit). The display device DSPL may be an EL (electroluminescent) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further include a storage device MMRY and a processing device PRCS separately from the storage circuit unit and the arithmetic circuit unit included in the photoelectric conversion device APR.

The equipment EQP illustrated in FIG. 24 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present invention is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present invention.

Further, the circuit configuration of the pixel 12 is not limited to the above-described embodiment. For example, a switch such as a transistor may be provided between the photoelectric conversion element 22 and the quenching element 24 or between the photoelectric conversion unit 20 and the pixel signal processing unit 30 to control the electrical connection state therebetween. Further, a switch such as a transistor may be provided between the node to which the voltage VH is supplied and the quenching element 24 and/or between the node to which the voltage VL is supplied and the photoelectric conversion element 22 to control an electrical connection state therebetween. A plurality of photoelectric conversion elements 22 may be provided for one pixel 12.

In the above-described embodiments, the counter circuit 34 is used as the pixel signal processing unit 30, but a TDC (Time to Digital Converter) and a memory may be used instead of the counter circuit 34. In this case, the generation timing of the pulse signal output from the waveform shaping circuit 32 is converted into a digital signal by the TDC. A control pulse pREF (reference signal) is supplied to the TDC from the vertical scanning circuit unit 40 via the control line 14 when the timing of the pulse signal is measured. The TDC acquires, as a digital signal, a signal when an input timing of a signal output from each pixel 12 is set to a relative time with reference to the control pulse pREF.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

According to the present invention, in a photoelectric conversion device that counts the number of periods in which avalanche multiplication occurs among a plurality of periods in which an APD is controlled to a standby state in which avalanche multiplication is possible, the number of periods in which avalanche multiplication occurs may be accurately counted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-141408, filed Aug. 31, 2023, which is hereby incorporated by reference herein in its entirety.

What is claimed is:

1. A photoelectric conversion device comprising:
an avalanche photodiode;
a first signal processing circuit including a first input node connected to one node of the avalanche photodiode and a second input node to which a periodic first control signal is input; and
a recharge circuit connected to the one node of the avalanche photodiode and configured to control a recharge operation of the avalanche photodiode in accordance with a periodic second control signal,
wherein the first signal processing circuit is configured to switch, in accordance with the first control signal, between a first mode in which an output value is changed in accordance with a signal to the first input node and a second mode in which a fixed value is output regardless of a signal input to the first input node, and
wherein the first signal processing circuit is configured to output once a first value in the first mode when avalanche multiplication occurs in the avalanche photodiode two or more times during one cycle of the second control signal.

2. A photoelectric conversion device comprising:
an avalanche photodiode;
a first signal processing circuit including a first input node connected to one node of the avalanche photodiode and a second input node to which a periodic first control signal is input; and
a recharge circuit connected to the one node of the avalanche photodiode and controlled by a periodic second control signal,
wherein the first signal processing circuit is configured to be controlled, in accordance with the first control signal, to a first mode in which an output value is changed in accordance with a signal to the first input node and a second mode in which a fixed value is output regardless of a signal to the first input node,
wherein the recharge circuit is configured to be controlled, in accordance with the second control signal, to a recharge operation mode in which a recharge operation in the avalanche photodiode is permitted and a quench operation mode in which a quench operation in the avalanche photodiode is permitted, and
wherein a period in which the recharge circuit is controlled to the recharge operation mode overlaps a period in which the first signal processing circuit is controlled to the second mode and does not overlap a period in which the first signal processing circuit is controlled to the first mode.

3. The photoelectric conversion device according to claim 2, wherein the first signal processing circuit outputs once a first value in the first mode when avalanche multiplication occurs in the avalanche photodiode two or more times during one cycle of the second control signal.

4. The photoelectric conversion device according to claim 2, wherein the first signal processing circuit includes a NOR circuit to which signals from the first input node and the second input node are input.

5. The photoelectric conversion device according to claim 4, wherein the first signal processing circuit further includes a Schmitt trigger circuit provided between the first input node and the NOR circuit.

6. A photoelectric conversion device comprising:
an avalanche photodiode;
a first signal processing circuit including a first input node connected to one node of the avalanche photodiode and a second input node to which a periodic first control signal is input; and
a recharge circuit connected to the one node of the avalanche photodiode and controlled by a periodic second control signal,
wherein the recharge circuit is configured to be controlled, in accordance with the second control signal, to a recharge operation mode in which a recharge operation in the avalanche photodiode is permitted and a quench operation mode in which a quench operation in the avalanche photodiode is permitted, and
wherein the first signal processing circuit is configured to
output a second value when the first control signal is at a first level, output a first value when the first control signal is at a second level different from the first level and the avalanche photodiode is in a discharge state in which avalanche multiplication does not occur, and
hold an output value when the first control signal is at the second level and the avalanche photodiode is in a standby state in which avalanche multiplication is possible.

7. The photoelectric conversion device according to claim 6, wherein the first signal processing circuit outputs once a first value when avalanche multiplication occurs in the avalanche photodiode two or more times during one cycle of the second control signal.

8. The photoelectric conversion device according to claim 6, wherein the first signal processing circuit includes an SR latch.

9. The photoelectric conversion device according to claim 8, wherein the SR latch is a NAND SR latch.

10. The photoelectric conversion device according to claim 2, wherein the first signal processing circuit outputs a second value when avalanche multiplication does not occur during one cycle of the second control signal.

11. The photoelectric conversion device according to claim 2, further comprising a second signal processing circuit connected to the first signal processing circuit.

12. The photoelectric conversion device according to claim 11, wherein the second signal processing circuit is a counter circuit.

13. The photoelectric conversion device according to claim 12, wherein the second signal processing circuit further includes a counter saturation detection circuit.

14. The photoelectric conversion device according to claim 2, wherein the first value is 1.

15. The photoelectric conversion device according to claim 10, wherein the second value is 0.

16. A photodetection system comprising:
the photoelectric conversion device according to claim 2; and
a signal processing device configured to process a signal output from the photoelectric conversion device.

17. The photodetection system according to claim 16, wherein the signal processing device generates a distance image representing distance information to an object based on the signal.

18. A movable object comprising:
the photoelectric conversion device according to claim 2;
a distance information acquisition unit configured to acquire distance information to an object from a parallax image based on a signal output from the photoelectric conversion device; and
a control unit configured to control the movable object based on the distance information.

19. Equipment comprising:
the photoelectric conversion device according to claim 2; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.

20. A method of driving a photoelectric conversion device including an avalanche photodiode, a first signal processing circuit including a first input node connected to one node of the avalanche photodiode and a second input node to which a periodic first control signal is input, and a recharge circuit connected to the one node of the avalanche photodiode and controlled by a periodic second control signal, the method comprising:
controlling, in accordance with the first control signal, the first signal processing circuit to a first mode in which an output value changes in accordance with a signal to the first input node and a second mode in which a fixed value is output regardless of a signal to the first input node, and
when the recharge circuit controls, in accordance with the second control signal, to a recharge operation mode in which a recharge operation in the avalanche photodiode is permitted and to a quench operation mode in which a quench operation in the avalanche photodiode is permitted,
controlling so that a period in which the recharge circuit is controlled to the recharge operation mode overlaps a period in which the first signal processing circuit is controlled to the second mode and does not overlap a period in which the first signal processing circuit is controlled to the first mode.
